(19) United States
(12) Patent Application Publication
(10) Pub. No.: US 2005/0033641 A1
(43) Pub. Date: Feb. 10, 2005

(54) System, method and computer program product for presenting directed advertising to a user via a network

(76) Inventors: Vikas Jha, Hillsborough, CA (US); Rahul Lahiri, Belmont, CA (US); Ram Subbaroyan, San Francisco, CA (US)

Correspondence Address: SQUIRE, SANDERS & DEMPSEY L.L.P, 600 HANSEN WAY, PALO ALTO, CA, 94304-1043, US

(21) Appl. No.: 10/913,662

(22) Filed: Aug. 5, 2004

Related U.S. Application Data
(60) Provisional application No. 60/493,022, filed on Aug. 5, 2003.

(51) Int. Cl. G06F 17/60

(52) U.S. Cl. 705/14

(57) ABSTRACT

A system method and computer program product for presenting an advertisement is described. A request to access a web page may be received from a requester via a network. The request to access the web page may be generated in response to selection of a link to the web page on another web page. A response may be transmitted back to the requester via the network. The response may include the requested web page as well as an ad script that may be executed after receipt of the response by the requester. The ad script may generate an ad request that includes one or more ad parameters extracted from the response. These ad parameters may include information about a network address of the other page. The generated ad request may then be received via the network. One or more advertisements may then be selected for presentment to the requester utilizing the ad parameters of the ad request.

### CROSS REFERENCE TO RELATED APPLICATIONS

This application claims the benefit of U.S. Provisional Patent Application Ser. No. 60/493,022, filed Aug. 5, 2003 which is incorporated by reference herein in its entirety.

### TECHNICAL FIELD

Embodiments of the present invention relate generally to online advertising, and more particularly to the targeting of advertisements to users of a network, including users of network-based search engines.

### BACKGROUND

A variety of methods exist for targeting ads to web site visitors. These methods include human categorization of web sites into predefined categories, for example, by Tribal Fusion (www.tribalfusion.com); automated categorization of web pages into categories based on content processing technologies, for example by Google AdSense (www.google.com); using aggregate profiles of site visitors such as the ones available from ComScore (www.comscore.com) or Nielsen/Netratings (www.nielsen-netratings.com), etc.

Search engines have been using search queries to target advertisements to search engine users on the search results pages. Google's AdWord program (www.google.com), and Overture's sponsored links programs (www.overture.com) are examples of this business. There exist applications that extract search engine query from a search engine referral visit. One such application is “Web Site Analytics”. An example of a web site analytics tool is FreeStats (http://www.freestats.coml/).

However, none of the methods provide processes for enabling web sites, as opposed to just the search engine sites, to target ads to users based on the search queries performed on the search engines that have referred visitors to the site. This web-site centric ad targeting may be performed either at an individual level in real-time, or at an aggregate level using the cumulative search referral information along with other factors.

Web publishers may generate revenue through advertising on their web sites. In many cases, a visitor may go to a particular web page as a result of being referred by a search engine like Yahoo! (www.yahoo.com) or Google (www.google.com). User may perform a search query on these search engines, and may then select one of the web pages shown as part of the result set of the query. Upon visiting this web page, user may be shown the content of the page, sometimes along with advertisements.

In order to make the advertisements relevant to the visitor, the ads may be chosen (“targeted”) based on the content of the web page, user profile, etc. among other factors. However, the search keywords/query used by the visitor on a search engine, immediately prior to being referred to the web site, are not used to target the ads shown to the visitor on the web site. These keywords/queries (also referred to as “search referral queries”) may be a predictor of what kind of ads would be appealing to the visitor.

### SUMMARY

A system method and computer program product for presenting an advertisement is described. A request to access a web page may be received from a requester via a network. The request to access the web page may be generated in response to selection of a link to the web page on another web page. A response may be transmitted back to the requester via the network. The response may include the requested web page as well as an ad script that may be executed after receipt of the response by the requester. The ad script may generate an ad request that includes one or more ad parameters that may be extracted, for example, from a browser application of the requester. These ad parameters may include information about a network address of the other page. The generated ad request may then be received via the network. One or more advertisements may then be selected for presentment to the requester utilizing the ad parameters of the ad request.

In one embodiment, the request may comprise a selection from a search result generated by a search engine in response to a search query initiated by the requester, and wherein the ad parameters include information about the search query. In such an embodiment, the search query may comprise one or more search terms, and wherein the ad parameters include the one or more search terms. The one or more search terms may be included in the information about the network address of the other page.

In another embodiment, the ad parameters may include a network location associated with a location of the requester. In a further embodiment, the ad parameters may include information about a publisher of the web page. In one implementation, the ad parameters may include a referrer URL and a publisher URL associated with the web page.

In a further embodiment, the selection of the one or more advertisements for presentment to the requester may include a determination of whether any advertisements of a set of advertisements matches criteria based on the ad parameters and then a selection of the advertisements from the set of advertisements that match the criteria.

In another embodiment, the information about past behavior of the requester may be collected. In such an embodiment, the ad parameters may include at least a portion of the information about past behavior the requester. The information about past behavior of the requestor may be stored with the help of a cookie. In such an embodiment, at least a portion of the information about past behavior of the requester may be accessed with the help of the cookie. As another option, the collected information about the past behavior may include information one or more previous search queries.

In one embodiment, information about previous accesses to the web page may be collected and used to determine a context of the web page. In such an embodiment, the context information about the web page may be utilized in the selection of the one or more advertisements. As another option, the collected information about the previous accesses to the web page may include information about one or more search queries used on a search engine that resulted in the selection of a link to the web page from the search results returned by the search engine in response to the search query.

In another embodiment, an account associated with at least one of the selected advertisements is charged a fee. In such an embodiment, the request may be categorized based on at least whether or not the request arises from a selection of a search result generated by a search engine in response to a search query. The fee charged to the account may be dependant on the categorization of the request.

### BRIEF DESCRIPTION OF THE DRAWINGS

FIG. 1 is a flowchart of a process 100 for ad targeting for a web page/web site in accordance with an embodiment of the invention.

FIG. 2 is a block diagram of an exemplary system at operation 102 of the process set forth in FIG. 1 where a user visits a search engine web page in accordance with an embodiment of the present invention.

FIG. 3 is a block diagram of an exemplary system at operation 104 of the process set forth in FIG. 1 where a user submits a search query via a search engine web page in accordance with an embodiment of the present invention.

FIG. 4 is a block diagram of an exemplary system at operation 106 of the process set forth in FIG. 1 where results of a search are presented to a user in accordance with an embodiment of the present invention.

FIG. 5 is a block diagram of an exemplary system at operation 108 of the process set forth in FIG. 1 where a user selects a direct link to a web page displayed in a search results page in accordance with one embodiment of the present invention.

FIG. 6 is a block diagram of an exemplary system at operation 108 of the process set forth in FIG. 1 in accordance with another embodiment of the present invention.

FIG. 7 is a block diagram of an exemplary system at operation 109 of the process set forth in FIG. 1 where a user directly requests a web page in accordance with an embodiment of the present invention.

FIG. 8 is a block diagram of an exemplary system at operation 110 of the process set forth in FIG. 1 illustrating an ad scrip included in a web page in accordance with an embodiment of the present invention.

FIG. 9 is a block diagram of an exemplary system at operation 112 of the process set forth in FIG. 1 where an ad script is executed by a browser application in accordance with an embodiment of the present invention.

FIG. 10 is a block diagram of an exemplary system at operation 114 of the process set forth in FIG. 1 where an ad request is transmitted to an ad server from the browser application in accordance with an embodiment of the present invention.

FIG. 11 is a block diagram of an exemplary system at operation 116 of the process set forth in FIG. 1 where an ad server selects and/or constructs advertisement(s) in accordance with an embodiment of the present invention.

FIG. 12 is a block diagram of an exemplary system at operation 118 of the process set forth in FIG. 1 where an ad server returns selected/constructed advertisement(s) in accordance with an embodiment of the present invention.

FIG. 13 is a block diagram of an exemplary system at operation 120 of the process set forth in FIG. 1 where a user selects one of the presented advertisements in accordance with an embodiment of the present invention.

FIG. 14 is a block diagram of an exemplary system at operation 122 of the process set forth in FIG. 1 where a browser application sends a request to a redirection server in accordance with an embodiment of the present invention.

FIG. 15 is a block diagram of an exemplary system at operation 124 of the process set forth in FIG. 1 where a redirection server logs tracking and billing information in accordance with an embodiment of the present invention.

FIG. 16 is a block diagram of an exemplary system at operation 126 of the process set forth in FIG. 1 where a browser application receives a redirection response from a redirection server in accordance with an embodiment of the present invention.

FIG. 17 is a block diagram of an exemplary system at operation 128 of the process set forth in FIG. 1 in accordance with an embodiment of the present invention.

FIG. 18 is a flowchart of a processes of utilizing an ad targeting algorithm in accordance with an embodiment of the present invention.

FIG. 19 is a flowchart of a process for directing an advertisement in accordance with an embodiment of the present invention.

FIG. 20 is a schematic diagram of an illustrative network system with a plurality of components in accordance with an embodiment of the present invention;

FIG. 21 is a schematic diagram of a representative hardware environment in accordance with an embodiment of the present invention;

### DETAILED DESCRIPTION

Embodiments of the present invention help to enable use of a search referral query and/or past search referral queries, among other factors, to target advertisements on web sites. Embodiments of the invention includes systems, methods, and computer program products for enabling selection and/or dynamic generation, collectively referred to as ad targeting, on web sites using search referral queries, among other factors. Embodiments of the present invention may not require this ad targeting to be done by a particular type of entity. It may be done by publisher, advertiser, or a third party, such as for instance, an ad serving network, among other entity types. Embodiments of the present invention may enable ad targeting for a particular visit of a user to a web site, using the search referral query in real-time, among other factors, for that visit. Embodiment of the present invention may also help to enable the association of a search referral query with a specific visitor. The search referral query, or queries, associated with a specific visitor, may be used, among other factors, to target ads for subsequent visits by the same visitor, within a configurable time period. This may allow search referral query based ad targeting even when a search referral query may not be available for that particular visit.

The invention also enables building a profile of a web page based on aggregated search referral queries, among other factors. This profile may then used, along with other factors, to target the ads. This kind of targeting, based on the web page profile, may be done either in conjunction with, or instead of, the targeting based on the search referral query associated with a particular visit, or a particular visitor, as described above, if/when such a search referral query may be available. In addition, the aggregate web page profiles enable building a profile for a whole web site that may be used to target ads for other pages on the web site. Embodiments of the present invention may also help to enable the establishing of different pricing strategies for different types of visitors, as determined by the referral type and referral information available.

It should be understood that these examples and Figures depict an embodiment of the invention. Embodiments of the present invention may be directed to selecting, generating, and placing objects such as, but not limited to, ads on web pages, when the page is displayed on data processing devices such as, but not limited to, a computer. Variations of these embodiments will be apparent to persons skilled in the relevant art(s) based on the information contained herein. For example, the flow charts contained in these Figures depict particular operational flows. However, the functions and steps contained in these flow charts may be performed in other sequences, as will be apparent to persons skilled in the relevant art(s) based on the information contained herein.

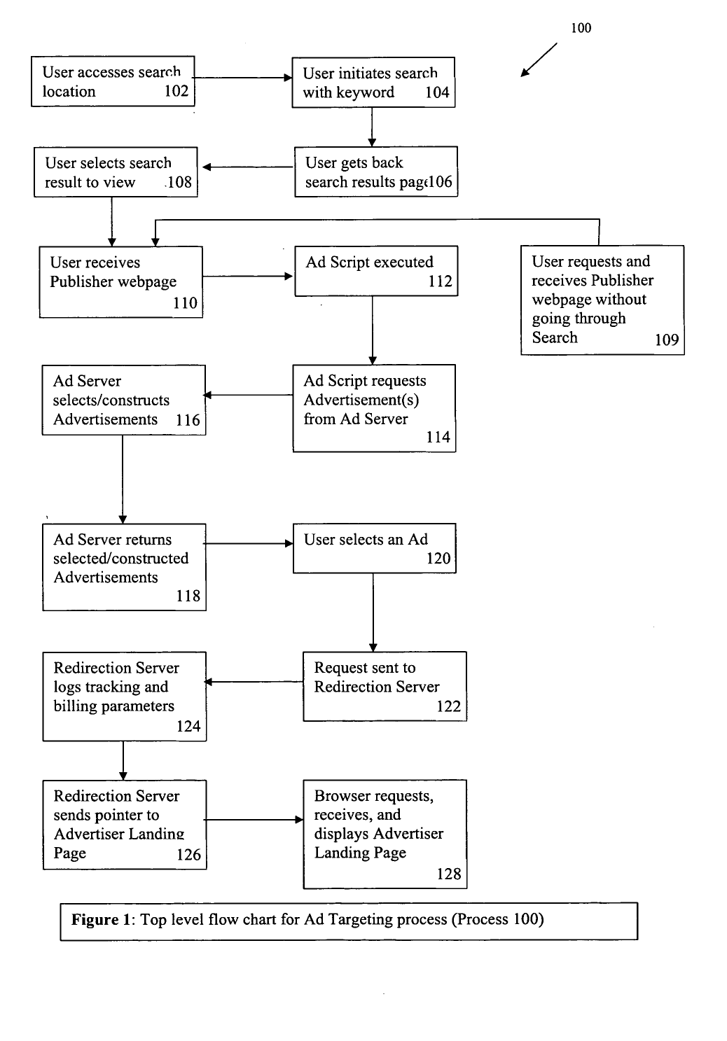

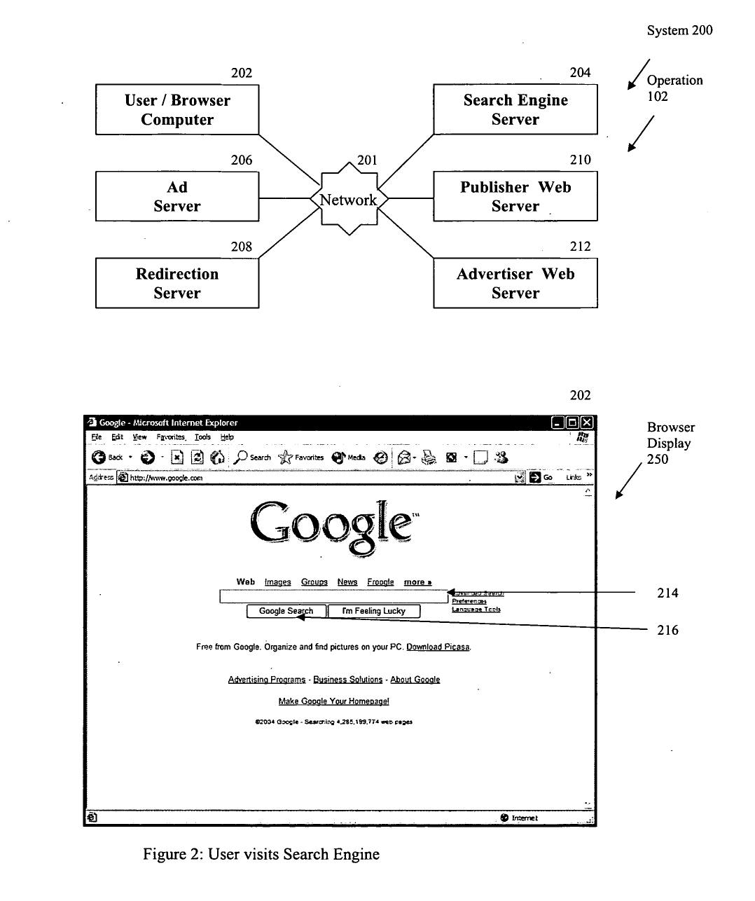

FIG. 1 is a flowchart of a process 100 for ad targeting for a web page/web site in accordance with an embodiment of the invention. In this embodiment, the process 100 may include the operations 102 through operation 128. These operations are described in greater detail in FIGS. 2 through 17.

In operation 102, a user may access a location for conducting a search, such as for example, a search of information in a database, a computer, and/or a network (e.g., a LAN, Internet, etc.). In one embodiment, the location may include a search box into which the user may input search query and/or other criteria for use in the network search. Exemplary locations include a web site/web page and/or a toolbar displayed in an application (e.g., a browser application) running on the user's computer.

In operation 104, the user may input search query into the location accessed in operation 102 (e.g., into the search box) and initiate a search. Exemplary ways of inputting search query include user clicking on a Hyperlink on a web site/web page that may already include a pre-selected search query.

The search using the search query may then be performed and the results of the search, referred to as search results, may be displayed to the user in operation 106.

In operation 108, the user may select one or more items from the search results displayed in operation 106. This selection may correspond to a web page that may be accessible by the user. We refer to this web page as a publisher web page.

As an another option, the user may request the publisher web page without first going through the search process (as described in operations 102 through 108) in operation 109. In one embodiment, the user may type in the URL of the publisher web page into an application (e.g., a browser application) running on the user's computer.

In operation 110, the user may receive the publisher web page selected in operation 108 or requested in operation 109. The publisher web page may include an ad script. In one embodiment, the ad script may be a Javascript program that may be executed by an application (e.g. a browser application) running on the user's computer.

In operation 112, the ad script received in operation 110 may be executed. As a result of this execution, the value of certain parameters, referred to as ad parameters, may be found. The ad parameters may include, among others, the referrer URL as well as the publisher web page URL. In one embodiment, the ad script may get the value of referrer URL from the Javascript variable named “document.referrer” and the value of publisher web page URL from the Javascript variable named “document.URL.”

In operation 114, the ad script may request, on behalf of the user, advertisement(s) from an ad server. As part of its request for advertisement(s) (also referred to as an “ad request”), the ad script may also send to ad server, the ad parameter values, which may have been extracted in operation 112, and/or other parameters. The value of some of these parameters may be based on the value of parameter values extracted in operation 112.

In operation 116, the ad server may target advertisement(s), based on at least the ad request sent in operation 114.

In operation 118, the ad server may return the targeted advertisement(s) selected/generated in operation 116. In one embodiment, the targeted advertisement(s) may be displayed in an application (e.g. a browser application) running the user's computer.

In operation 120, the user may select one of the advertisement(s) that may have been displayed in operation 118.

In operation 122, a request corresponding to the advertisement selected in operation 120 may be sent, on behalf of the user, to a redirection server.

In operation 124, the redirection server may store billing and tracking information related to the visitor, publisher, advertiser, advertisement(s) displayed in operation 118, advertisement selected in operation 122.

In response to the request sent to the redirection server in operation 122, a response that includes an advertiser landing page URL may be sent to the user in operation 126.

In operation 128, the user may request the advertiser landing page, as identified in operation 126, from an advertiser web server. Advertiser web server may send the requested advertiser landing page back. In one embodiment, the advertiser landing page may be displayed in an application (e.g. browser) running on the user's computer.

FIGS. 2 through 17 illustrate an exemplary implementation of the process 100 set forth in FIG. 1. FIGS. 2-17 each include a block diagram of an architecture of an exemplary system 200 that is a logical representation of the computers/servers that may be involved in process 100, and a browser display 250 which is a schematic representation of a display that may be presented to a user via a browser 202 running on the user's computer, during the process 100. It should be understood that the description of FIGS. 2 through 17 make use of examples to illustrate an exemplary implementation of the process 100, however, embodiments of the invention are not limited to these examples.

System 200 includes a user/browser computer 202, a search engine server 204, an ad server 206, a redirection server 208, a publisher web server 210, an advertiser web server 212, and a network 201 connecting all these components. Exemplary implementations of system 200 may include one or more of these logical computers/servers running on the same actual computer, possibly with other software or logical servers. Exemplary implementations may also include one or more of these logical computers/servers running on a cluster of actual computers/servers.

FIG. 2 illustrates operation 102 in which a user may visit a search engine on the World Wide Web (WWW), such as for example, www.google.com, in order to search through web pages found on the WWW. FIG. 2 also illustrates, in browser display 250, a web page that the user may see upon visiting the search engine. The web page may include a search box 214 into which the user may input one or more search query and/or other criteria and a search button 216 that, upon selection by the user, may initiate the search using the search query.

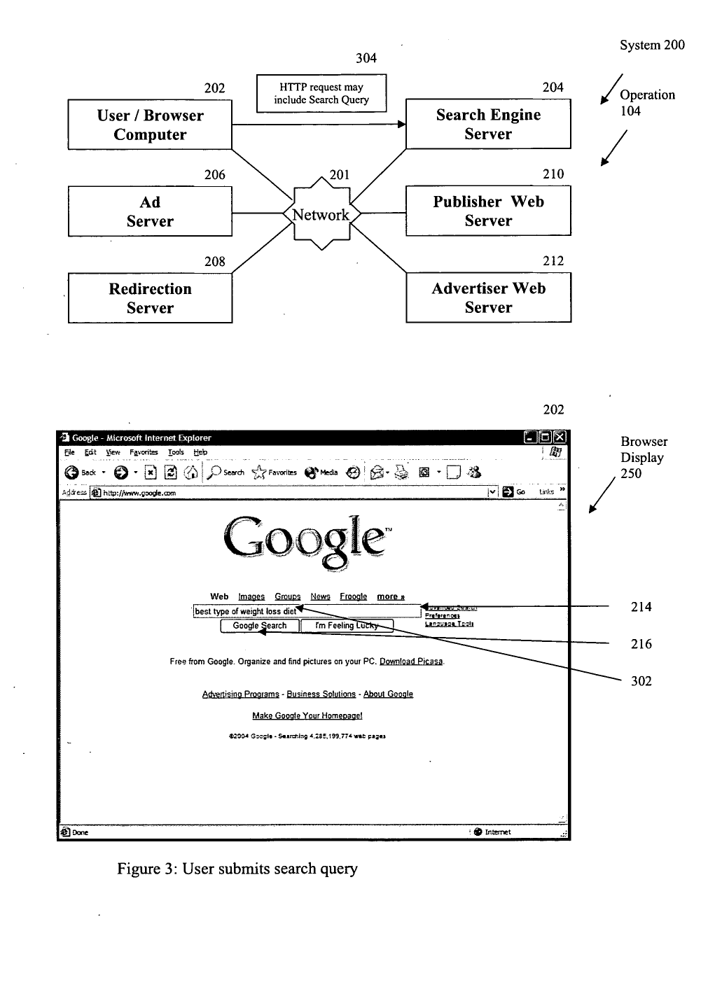

As shown, FIG. 3 illustrates operation 104 in which the user may input the search query 302, such as for example, “best type of weight loss diet”, into the search box 214, and may select search button 216. The search query may then be transmitted to the search engine server, in form of an HTTP request 304, using a protocol such as HTTP. FIG. 3 also illustrates a web page that the user may see prior to selecting search button 216.

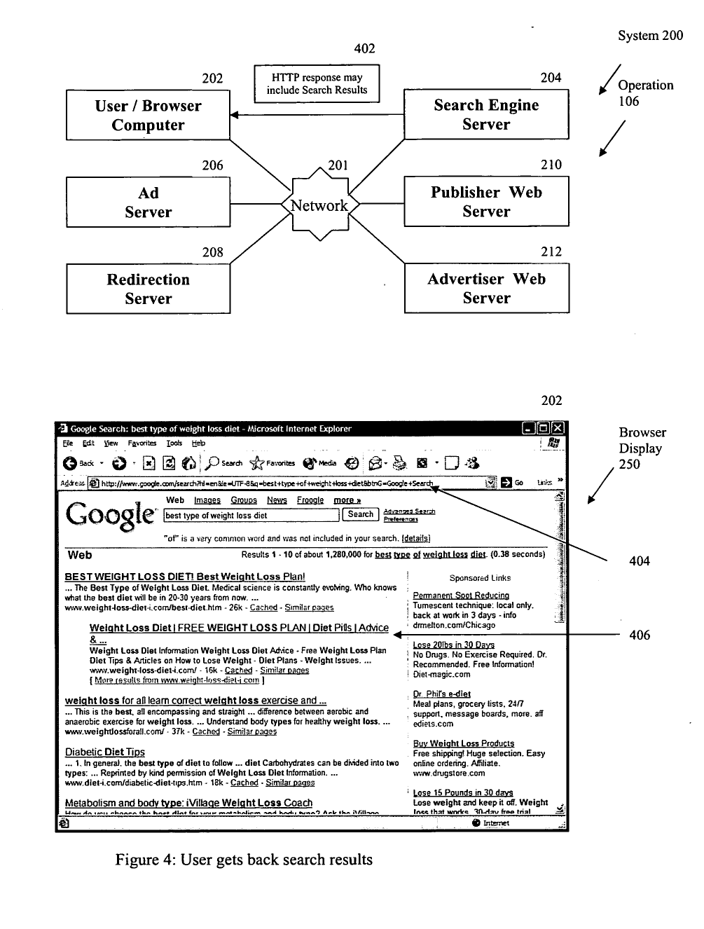

FIG. 4 illustrates operation 106 in which the search engine server may execute search based on the search query 302 entered in operation 104, and return a formatted search results page. Search results page may contain zero or more search results 406. Search results page may be sent back to the browser, in form of an HTTP response 402, using a protocol such as HTTP. FIG. 4 also illustrates how the Search results page may be displayed to the user in the browser. Each result entry may correspond to a web page that may be related to the search query 302 entered in operation 104. Search results page may include hyperlinks to more search results pages that may include more result entries. The Search referral URL 404 may contain the search query (also referred to as a “search referral query”), input by the user in operation 104. In the example shown in FIG. 4, the search referrer URL is http://www.google.com/search?hl=en&ie=UTF-8&q=best+type+of+weight+loss+diet&btnG=Google+Search. As shown in FIG. 4, the search referrer URL 404 may be displayed in an “Address” field displayed in the browser application. As can be seen in this example, the search referral query, “best type of weight loss,” may be embedded in the search referral URL, and may be extracted from it.

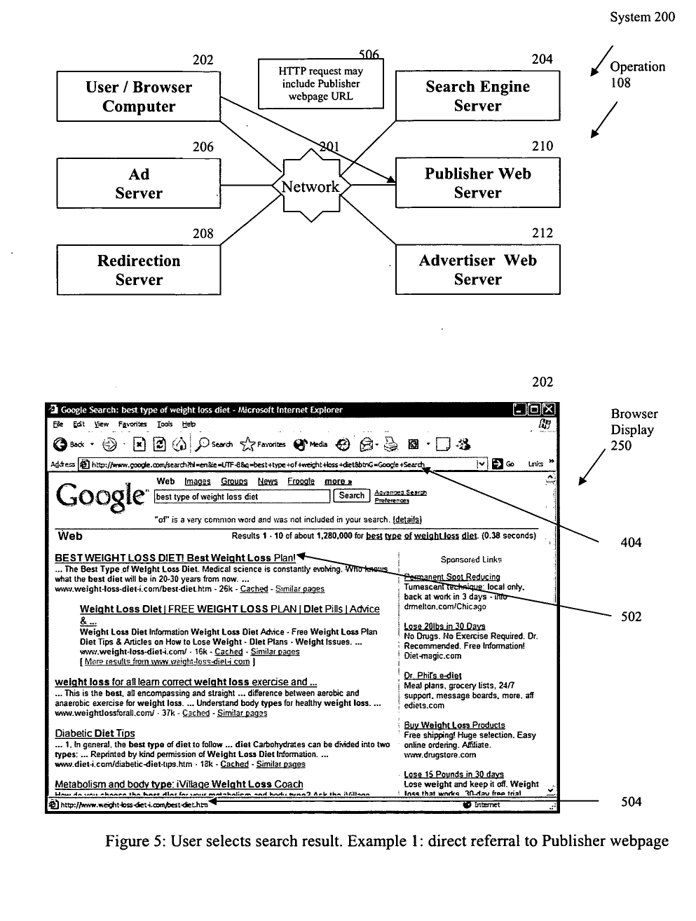

FIG. 5 illustrates operation 108 in which the user may select one of the search results entries received in operation 106. This selection may be accomplished by selecting the corresponding hyperlink 502 on the search results page, such as for example, the hyperlink titled “BEST WEIGHT LOSS DIET! Best Weight Loss Plan!” in FIG. 5. Hyperlink 502 may include a link to a publisher web page URL 504, http://www.weight-loss-diet-i.com/best-diet.htm, in this example. Selecting the hyperlink 502 may result in an HTTP request 506 being sent by the browser to publisher web server 210 (that may include the publisher's web page URL 504).

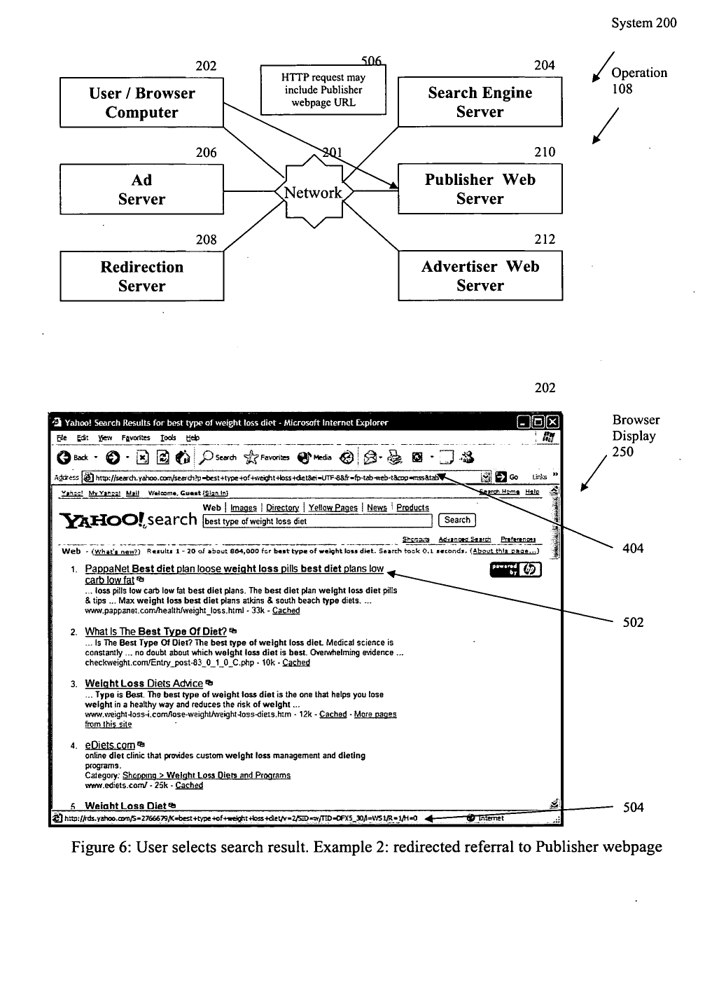

FIG. 6 illustrates another embodiment of operation 108 in which the user may select one of the search results entries received in operation 106. This selection may be accomplished by selecting the corresponding hyperlink 502 on the search results page. The hyperlink 502 may include a link to another web page, referred to as a redirecting web page. Selection of hyperlink 502, may result in the browser requesting and receiving the redirecting web page. The redirecting web page may include a pointer to the publisher web page, or a pointer to another redirecting web page. By following the chain of redirecting web pages, the browser may eventually send an HTTP request 506 to the publisher web server 210.

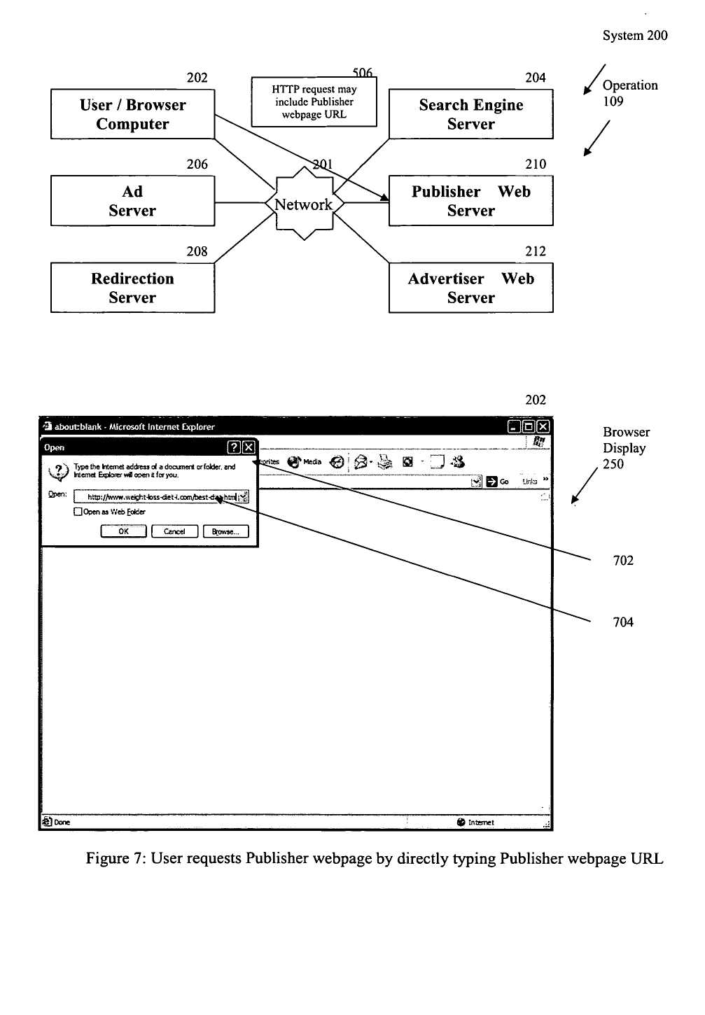

FIG. 7 illustrates operation 109 in which the user may request the publisher web page without first going through a search process similar to one described in operations 102 through 108. In one embodiment, the user may enter the publisher web page URL 704 into a browser open box 702, followed by selecting the “Open” button. Exemplary ways of requesting the publisher web page may include selecting a hyperlink located on a web page that is not a search result page. Such a hyperlink may include a link to the publisher web page. Yet another exemplary way to request the publisher web page may be to use the bookmarks feature of the browser.

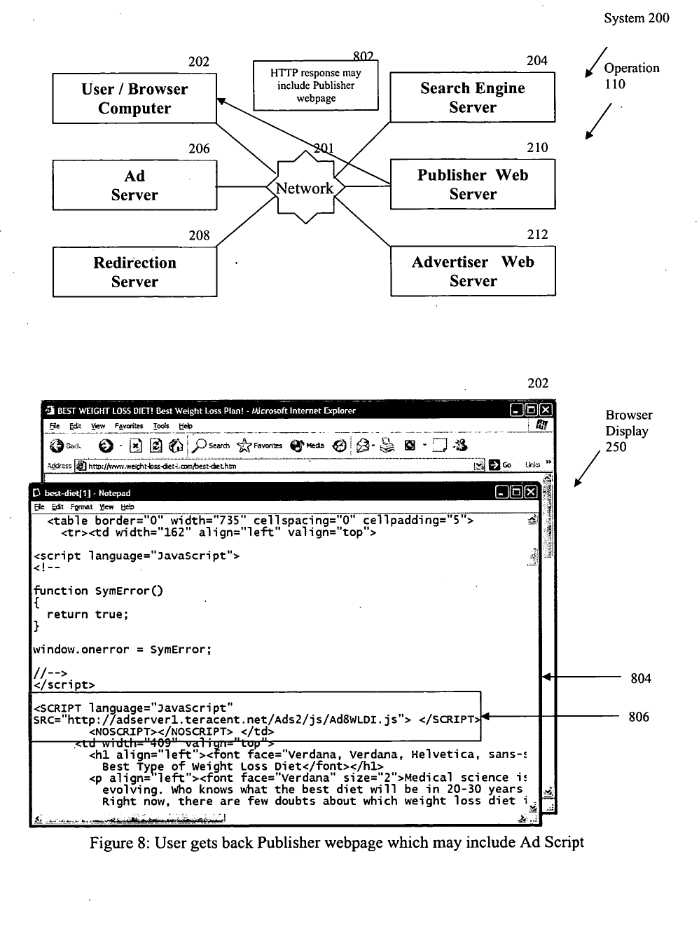

FIG. 8 illustrates operation 110 in which the browser may receive an HTTP response 802 from the publisher web server 210. This response may contain the publisher web page selected in operation 108 or requested in operation 109. The publisher web page may include an ad script. Ad script may be a general computer program that helps in the requesting, selection, and display of advertisement(s) on the publisher web page. In one embodiment, as illustrated in FIG. 8, the ad script may be a Javascript program 806. Some of the browsers may allow user to view the “source” of the web page being viewed. Source may refer to the web page text returned as part of the HTTP response 802, viewed in its original form, with all the formatting commands, scripts, embedded URLs etc. FIG. 8 also illustrates “view source” browser window 804 that displays the HTML source corresponding to the web page displayed in browser display 250.

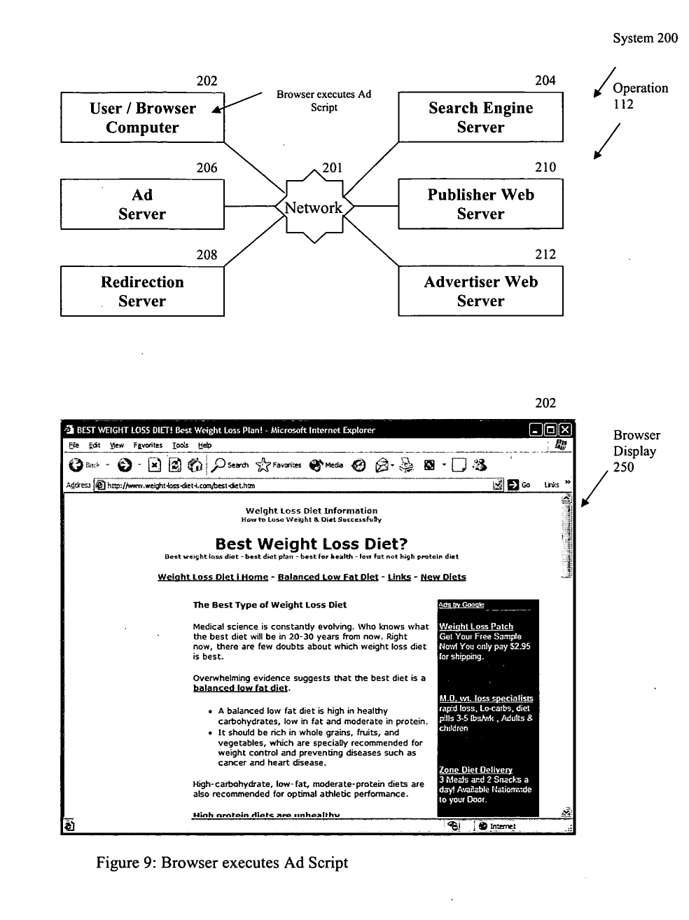

FIG. 9 illustrates the operation 112 in which the browser may execute the ad script received in operation 110. In one embodiment, during this execution, ad script may extract the referrer URL stored in the special Javascript variable called “document.referrer,” and the publisher URL from the special Javascript variable called “document.URL.” If the user had requested the publisher web page by selecting a corresponding search result entry, as described in operation 108, the referrer URL may be the same as the search referral URL 404.

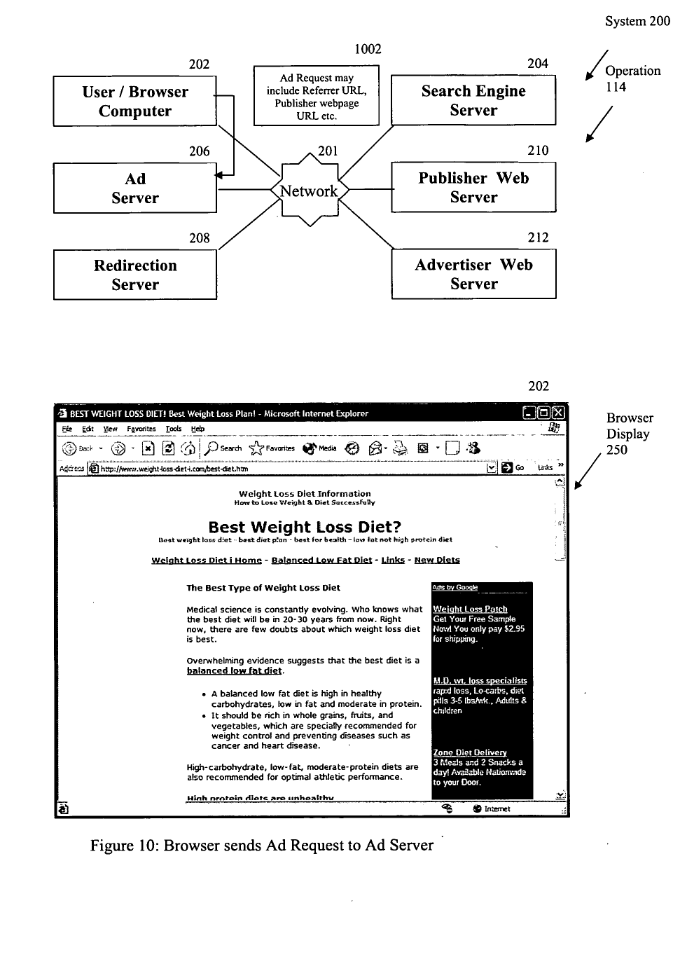

FIG. 10 illustrates the operation 114 in which the ad script, running on the browser, may send an ad request 1002 to the ad server 206. The ad request 1002 may include the values of referrer URL and publisher web page URL, as extracted in operation 112. The ad request 1002 may also include other parameters, such as for example, a user's IP address.

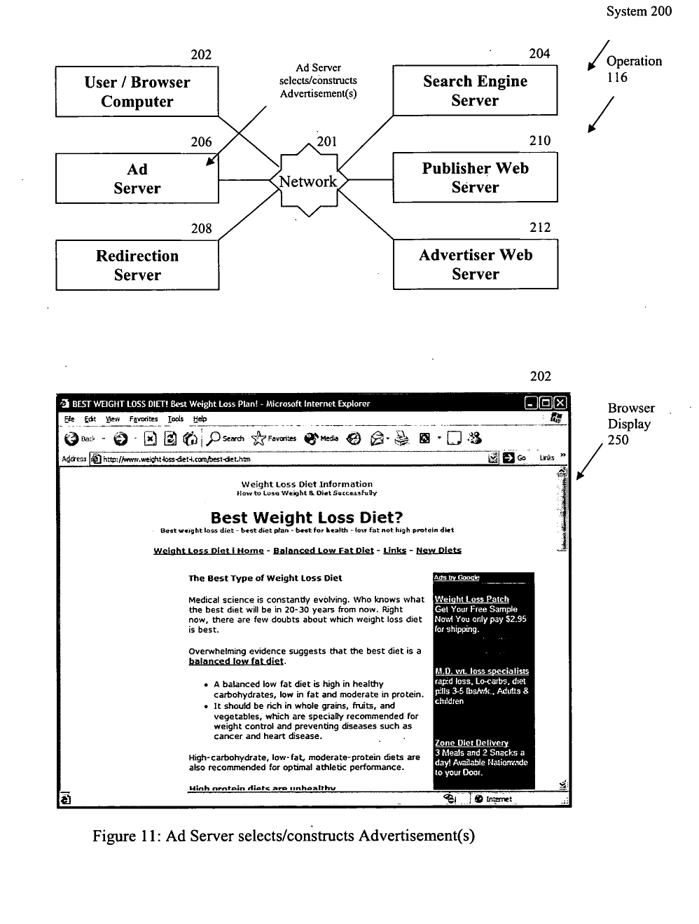

FIG. 11 illustrates the operation 116 in which the ad server may target advertisement(s), in response to the ad request 1002 sent in operation 114. An ad targeting algorithm may refer to a method used to select and/or construct advertisement(s), based on available information.

In one embodiment, the ad server may select the advertisement(s) from a set of advertisement(s) stored in a local database. Exemplary ways of selecting advertisement(s) include requesting advertisement(s) from other computer(s), network(s), or remote database(s). In addition to selecting advertisement(s), the ad server may also dynamically construct, and/or request other computer(s) to dynamically construct on its behalf, advertisement(s), or portions of advertisement(s). The selection and/or construction of advertisement(s) may be based on ad parameter values sent by the ad script as part of the ad request 1002, and/or other information available to the ad server.

One of the parameters that the ad server may take into account, in selecting/constructing advertisement(s) is the referrer URL that may have been included in the ad request 1002 sent by ad script. If the user had requested the publisher web page by selecting a corresponding search result entry, as described in operation 108, the referrer URL may be the same as the search referrer URL 404, such as for instance http://www.google.com/search?hl=en&ie=UTF-8&q=best+type+of+weight+loss+diet&btnG=Google+Search . The ad server may be able to extract the search query, such as for instance “best type of weight loss diet”, that may be embedded in the referrer URL. The search query, when available, may provide clues to the user's interests. Therefore, it may be a useful factor in selecting/constructing advertisement(s) to show to the user.

In another embodiment, the ad server may be able to extract the search query in another way. Such as, for instance, the browser may send the referrer URL to the publisher web server, as part of the HTTP request for the publisher web page, in form of a particular header called HTTP_REFERRER, which is a part of HTTP. The publisher web server may extract the search query, if available, from the referrer URL, and may use it to select/construct advertisement(s), and may include those advertisement(s) in the publisher web page returned to the user.

In addition to, or in place of search query, the ad server may take past search query into account, in selecting/constructing advertisement(s). Past search query may refer to a search query that the current user may have used in order to find and access any other web page in the past. It may be possible for the ad server to remember one or more of the search queries that a particular user, as identified by his browser, may have used on search engine, such as for example www.google.com or www.yahoo.com, through the use of cookies. Ad server may store the search query, as extracted using one of the ways described above, or any other way, in an accessible database, along with the user's cookie. Subsequently, if the ad server encounters the same cookie in another ad request, it may take the past search query associated with that cookie, if any, as found in the accessible database, into account, in selecting/constructing advertisement(s).

The ad server may also take into account several other parameters such as geo-location of the user as inferred from user's IP address, advertiser preferences, publisher preferences, etc. to select/construct the advertisement(s).

In addition to selecting and/or constructing advertisements, the ad server may also store one or more of the parameter values such as for example, the user identity as determined by the cookie, search referral query, if available, publisher web page URL, referrer URL, the IP address of the user's computer, date and time of the request, etc. in the accessible database for future use.

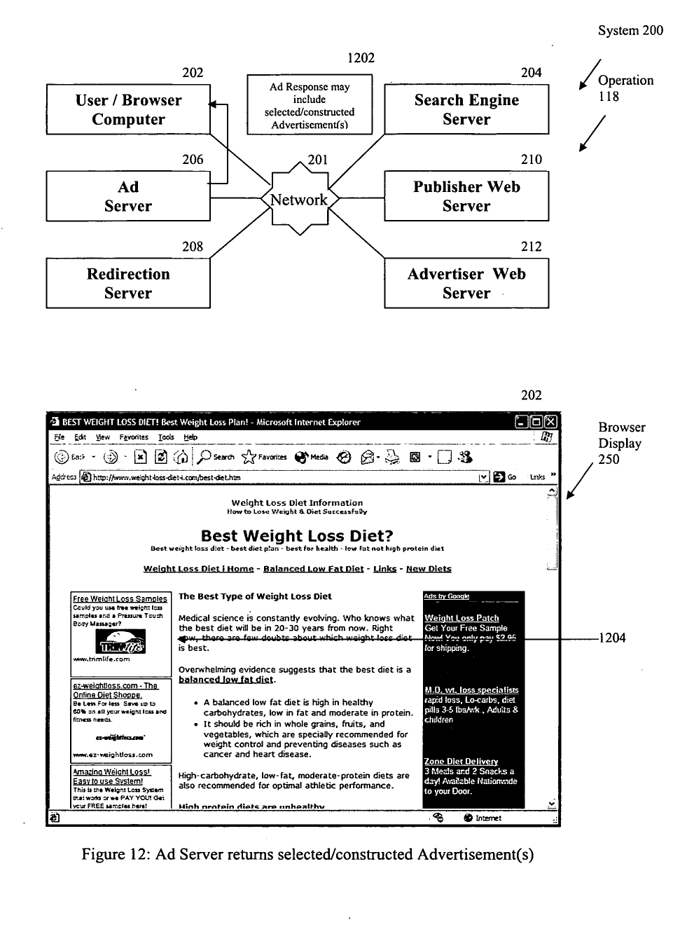

FIG. 12 illustrates operation 118 in which ad server may send ad response 1202 back to the user. Ad response 1202 may contain zero or more advertisement(s) selected/constructed by the ad server in operation 116. FIG. 12 also illustrates, in browser display 250, how a publisher web page, including the advertisement(s) 1204 returned by the ad server may be displayed to the user.

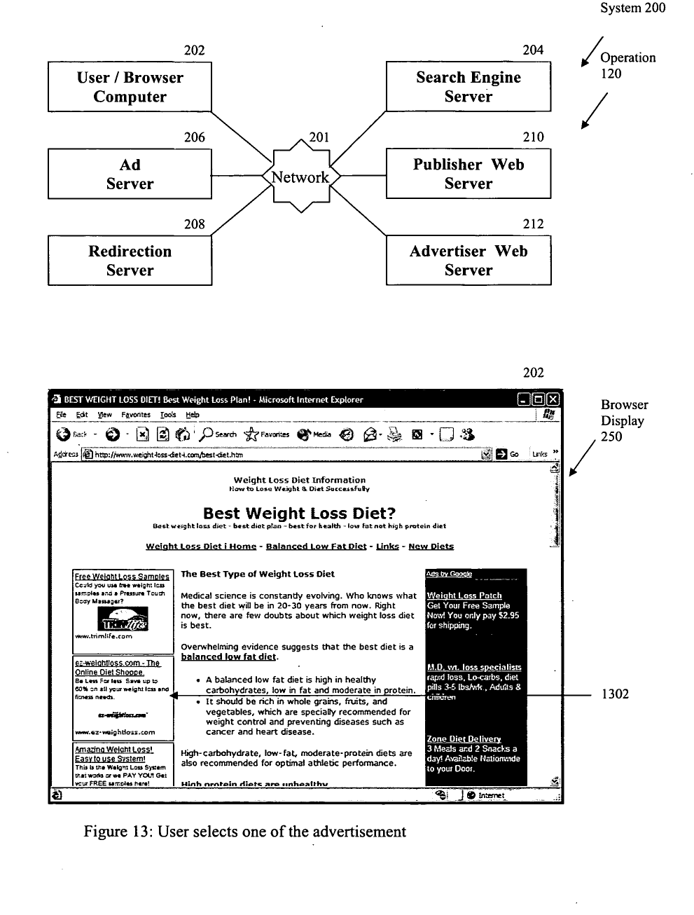

FIG. 13 illustrates operation 120 in which the user may select one of the advertisement(s) 1302 displayed in operation 118. In the example illustrated in FIG. 13, the selected advertisement is titled “ez-weightloss.com—The Online Diet Shoppe”.

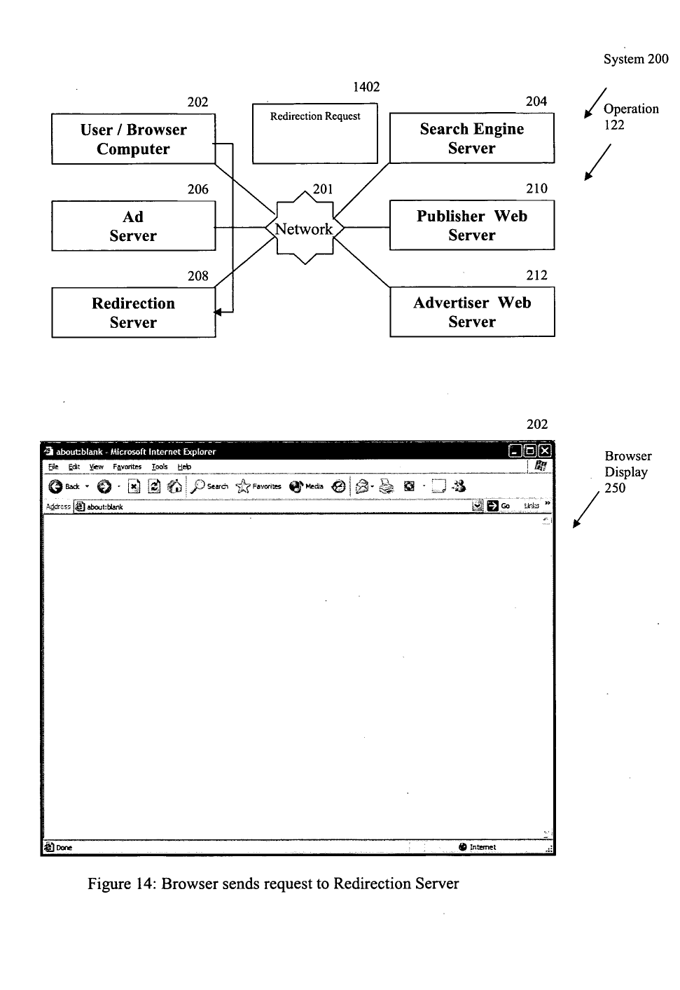

FIG. 14 illustrates operation 122 in which the browser may send a redirection request 1402, corresponding to the advertisement 1302 selected in operation 118, to a redirection server 208.

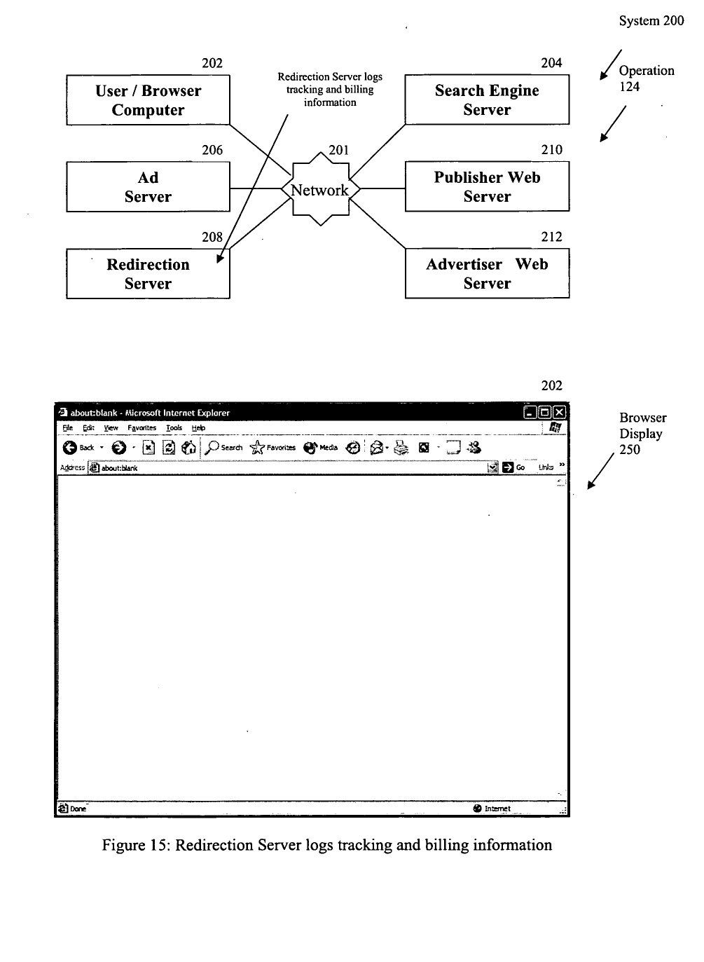

FIG. 15 illustrates operation 124 in which the redirection server may store information related to billing, targeting, and other purposes into a database. This information may include, for example, user IP address, time, publisher web page URL, advertiser landing page URL, ad position in list of ads, and price.

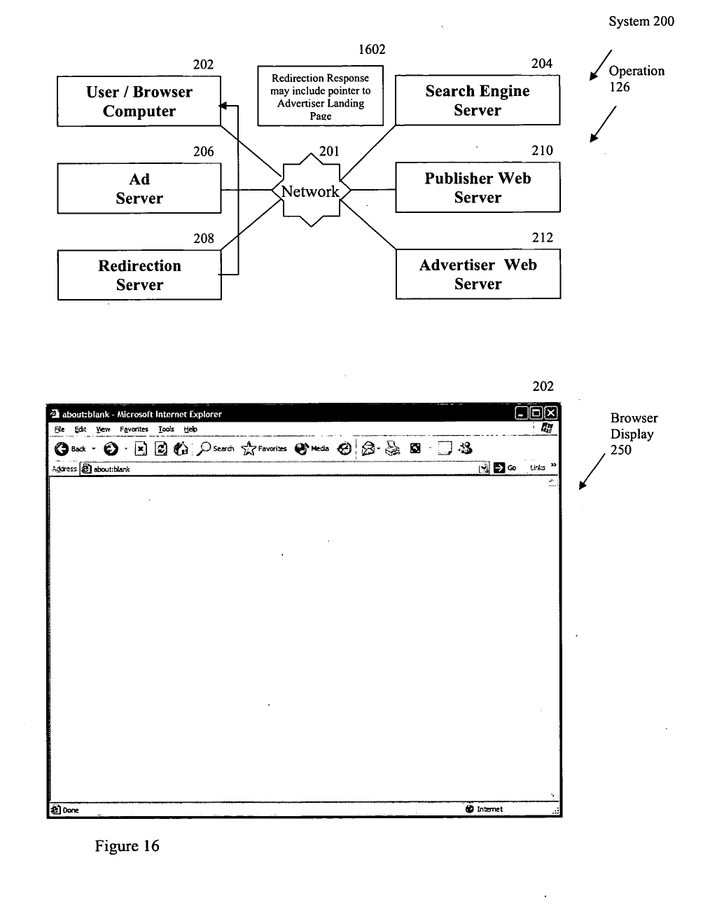

FIG. 16 illustrates operation 126 in which redirection response 1602 may be sent back to the browser, in response to the request 1402 sent in operation 122. Redirection response 1602 may include pointer to advertiser landing page.

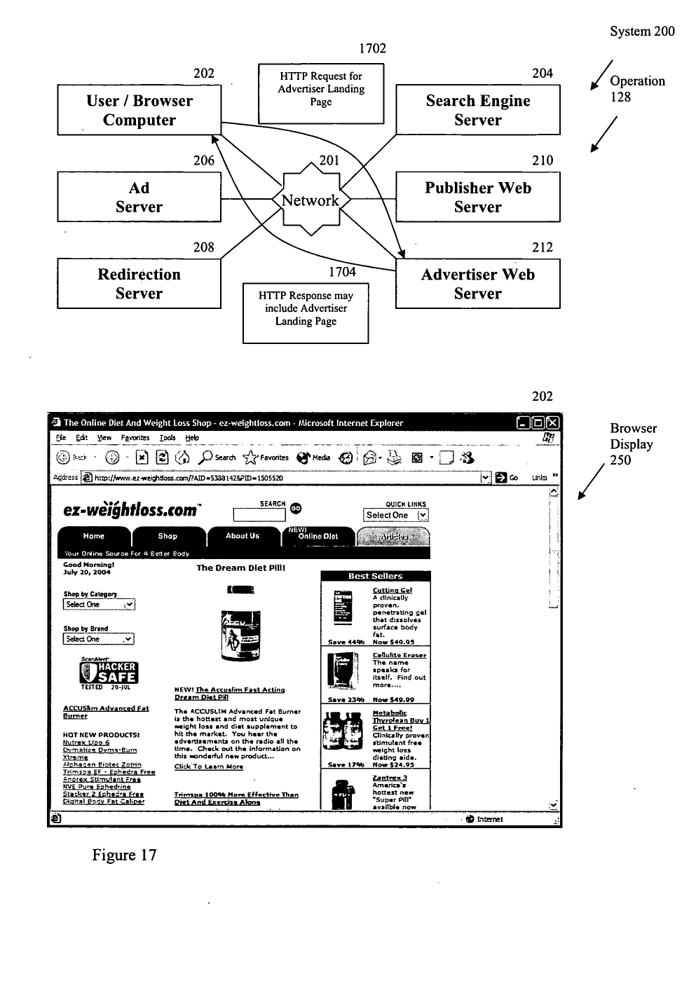

FIG. 17 illustrates operation 128 in which browser may send an HTTP request 1702 to advertiser web server 212. HTTP request 1702 may include the advertiser landing page URL that may have been received in operation 126. In response to the HTTP request 1702, the advertiser web server may send back an HTTP response 1704 to the browser. HTTP response 1704 may include the advertiser landing page. FIG. 17 also illustrates, in browser display 250, how the advertiser landing page may be displayed to the user.

### Ad Targeting Algorithm

An ad targeting algorithm may refer to a method used to select and/or construct advertisement(s), based on available information. In one embodiment, ad targeting algorithm may be used to select zero or more advertisement(s) from a set of available pre-defined advertisement(s), based on available information. In another embodiment, the ad targeting algorithm may be used to dynamically construct advertisement(s), based on available information. In yet another embodiment, ad targeting algorithm may be used to select some advertisement(s) and dynamically construct other advertisement(s). In yet another embodiment, portions of the resulting advertisement(s) may be pre-defined, and the rest may be dynamically constructed.

As an example, an ad targeting algorithm may be used in operation 116 of process 100.

Inputs used by the ad targeting algorithm may include the following:
Ad database which may include all available advertisement(s).
Search referral query, if available, for the current visit to the given web page.
One or more past search referral queries, if available, associated with the current visitor.
Publisher profile, as described in detail below, of the given publisher web page.
Advertiser profile, as described in detail below, of all advertisement(s) in ad database.
User profile, as described in detail below, of the current user.
Advertiser budget.
Advertiser preferences.
Publisher preferences.
Ads previously shown, along with their frequency, to this user.
Advertiser bid price.
Click-through rate (CTR) of a particular ad on a particular web page.
Conversion Rate (CR) of a particular ad on a particular web page.

Output of the ad targeting algorithm may include a set of selected/constructed advertisement(s) that may be sent back to browser for display.

### Publisher Profile

Publisher profile may include information about a given web page that may be relevant in deciding what type of ads to display alongside that web page. This may include the following:

(1) Publisher profile/Content profile may refer to the information that may be based on the analysis of the content of the web page. This may include:

(1a) Publisher profile/Content profile/Term Collection may refer to a collection of words, and their frequencies, appearing in the given publisher web page. In one embodiment, these words may be extracted from the document by using a parser specific to the formatting language used to format the document. Such as for example, an HTML parser may be used to parse an HTML page. The effect of using a parser may be to exclude the formatting commands like HTML tags, and extract only the words that may be visible to a user visiting the page. Further, the frequency of occurrence of these words may be weighted by several coefficients. These coefficients may include (i) IDF (Inverse Document Frequency), (ii) specific weights based on the part of the document where the word occurs e.g. higher weight if the word occurs in the paragraph heading that if the word occurs in the body of the paragraph.

(1b) Publisher profile/Content profile/Auto Category may refer to the category of the web page content, as may be determined by a specialized “auto-categorization” program.

(1c) Publisher profile/Content profile/Manual Category may refer to the category of the web page content, as specified by a human.

(2) Publisher profile/Search query profile may include search referral queries extracted from search referrer URLs, corresponding to search referred visits to the given publisher web page, over a configurable period of time.

(3) Publisher profile/Referrer profile may refer to the information based on web pages that link to the given web page. This may include the following:

(3a) Publisher profile/Referrer profile/Referrer Pages may include a list of referrer web pages, over a configurable period of time, as well as the percentage of all page visits that may be referred by each one of them.

(3b) Publisher profile/Referrer profile/Content profile may include content profile of each of the referrer pages.

(3c) Publisher profile/Referrer profile/Anchor profile may include anchor text of each of the referrer pages.

(4) Publisher profile/Visitor profile may include the demographic information about the visitors to given publisher web page, in an aggregate form. Such as for instance, “percentage of total visits that are from male visitors is X”. Some of this information may be collected from 3rd party sources like ComScore (www.comscore.com). Also, the visitor profile (or parts of) of a given publisher web page may be applied, with appropriate weights, to a different page that is a part of the same web site, or is otherwise “similar” to it. The specific elements of the Visitor profile may include, for example: Gender, Age group, Salary, Access from home/work, Profession, Interests(sports, knitting, archery, drinking etc.), Language preference, and Nationality/ethnicity.

### Advertiser Profile

Advertiser's profile may include information about a given advertisement that may be relevant in deciding what type of web pages to display that advertisement on. This may include the following:

(1) Advertiser profile/Keyword profile may refer to the keywords or phrases that may be specified by the advertiser, corresponding to the given advertisement.

(2) Advertiser profile/Descriptive text may refer to a short text description the advertiser may provide with the given advertisement, and may be included when the ad is displayed.

(3) Advertiser profile/Click-through profile includes historical information about the click-through-rate (CTR) generated by the given advertisement, when it may have been displayed on a particular web page, web site, or a set of similar web pages and/or web sites.

(4) Advertiser profile/Conversion profile includes historical information about the conversion rate (CR) generated by the given advertisement, when it may have been displayed on a particular web page, web site, or a set of similar web pages and/or web sites.

(5) Advertiser profile/Content profile may be based on the content of the advertiser landing page for the given advertisement, as well as the content of the advertiser web site. This may include term collection, corresponding to the terms appearing the content, as well as manual and auto-categorization of the content.

(6) Advertiser profile/Geo-profile may include historical information about geo-location data, based on user IP address, for users selecting the given advertisement. This may also include historical information about geo-location data, based on user IP address, for users taking certain actions, such as for example, buying products, after selecting the given advertisement.

(7) Advertiser profile/Visitor profile may include information provided by the advertiser about the visitors that the advertiser may wish to display the given advertisement to. This may also include information automatically collected about the type of visitors that display preference for the given advertisement, as inferred from users selecting the given advertisement, or specific actions taken by users after selecting the given ad, such as for example, purchasing the advertised product.

### Visitor Profile

Visitor profile may include information about a given visitor that may be relevant in deciding what type of advertisement(s) to display to him/her. This may include the following:

(1) Visitor profile/Visitor categories may refer to the categories that the given user may belong to. It may be possible to categorize each visitor into multiple categories. Examples of visitor categories include “office user,” “home user,” “sports enthusiast”, “electronics enthusiast.” Categories may be hierarchical as well. Note that a given visitor may belong to more than one visitor categories. Various techniques may be used to map visitors into one or more categories. For instance, using Cookies, it might be possible to track the web pages that a given visitor has visited, over a period of time. Based on an analysis of the content of these pages, it may be possible classify the visitor. For instance, if a visitor visits sports pages frequently, it may be reasonable to classify him/her as a “sports enthusiast.”

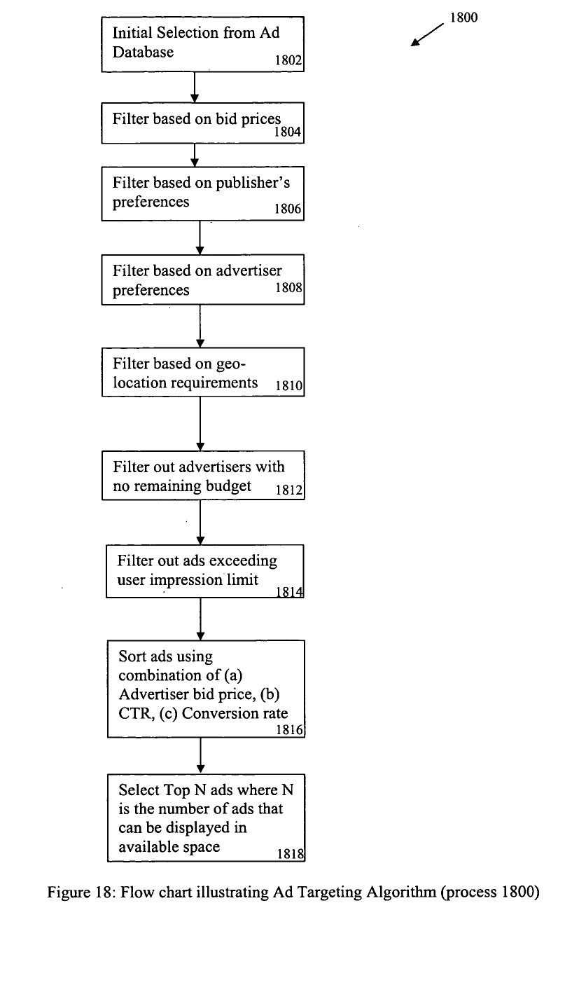

FIG. 18 is a flowchart of a process 1800 for ad targeting algorithm in accordance with an embodiment of the invention. In this embodiment, the process 1800 may include the operations 1802 through operation 1818. This embodiment describes selection of advertisement(s). Other similar embodiments may be used to dynamically generate advertisement(s) in addition to, or in place of, selecting advertisement(s).

In operation 1802, an initial set of relevant advertisement(s) may be selected from the Advertisement database, using available information including search referral query, past search referral queries, publisher profile, and advertiser profile. For instance, if the search referral query includes keywords “Low Calorie Diet,” then all advertisement(s) whose advertiser profile/Keyword profile includes “Low Calorie Diet” may be selected in operation 1802. In another example, if the publisher profile/Content profile/Term Collection for the publisher web page includes keywords “Low Calorie Diet,” then all advertisement(s) whose advertiser profile/Keyword profile includes “Low Calorie Diet” may be selected in operation 1802.

In operation 1804, the advertisement(s) remaining after operation 1802, that do not satisfy the bid price requirements, may be filtered out. For instance, if a max bid price specified for an advertisement is lower than the min bid price specified by the publisher, then the ad may not satisfy the bid price requirement for that publisher web page.

In operation 1806, the advertisement(s) remaining after operation 1804, that do not satisfy the advertiser preferences, may be filtered out. For instance, an advertiser may require that their ads not be displayed on a specific web site.

In operation 1808, the advertisement(s) remaining after operation 1806, that do not satisfy the publisher preferences, may be filtered out. For instance, a publisher may require that no ads from a specific advertiser be displayed on their web site.

In operation 1810, the advertisement(s) remaining after operation 1808, that do not satisfy the geo-location requirements, may be filtered out. For instance, if the current visitor is from San Francisco bay area metro region, and a particular ad is intended to be shown only to a visitor from New York region, then that ad may be filtered out.

In operation 1812, the advertisement(s) remaining after operation 1810, that do not satisfy the available budget requirements, may be filtered out. For instance, an advertiser may have specified a $50 daily budget for a particular ad. Once that budget has been spent, the ad may be filtered out for the rest of the day.

In operation 1814, the ad(s) remaining after operation 1812, that do not satisfy the impression limit, may be filtered out. For instance, if a particular ad has been displayed to the same user 10 times in past 24 hours, and that ad has an impression limit of “10 in 24 hours”, then that ad may be filtered out.

In operation 1816, the ad(s) remaining after operation 1814 may be sorted using a combination of (a) advertiser bid price, (b) click-through-rate, (c) conversion-rate. In one embodiment, the ads may be sorted in a decreasing order by advertiser bid price. In another embodiment, the ads may be sorted in a decreasing order by click-through-rate. In yet another embodiment, the ads may be sorted in a decreasing order by conversion-rate. In yet another embodiment, the ads may be sorted in a decreasing order by the product of click-through-rate and bid price. In yet another embodiment, the ads may be sported in a decreasing order by the product of commission and conversion rate.

In operation 1818, the top N ads, from the sorted ad list from operation 1816, may be selected where N is the maximum number of ad(s) that may fit in the space provided on the publisher web page. If the number of available ads is less than N, then all the ads may be selected.

### Ad Pricing

Ad pricing may refer to the mechanism(s) by which an advertiser may pay, using real currency or an optional non-cash credit currency, the publisher for displaying the ad(s). The ad pricing mechanisms discussed here may be used in conjunction with established payment/pricing models in the industry, such as for example, (a) pay per impression: advertiser pays each time his/her ad is displayed, (b) pay per click: advertiser pays each time his/her ad is selected (clicked) by the user, (c) pay per qualified lead: advertiser pays each time his/her ad is selected by a particular type of user, sometimes requiring the user to fill out a form, (d) pay per sale: advertiser pays each time his/her ad is selected by a user, and that selection leads to an actual sale.

Visit type-dependent pricing: An ad's click-through-rate, as well as conversion rate, may depend on the user's interest level in the ad. A visitor's interest level may vary from visit to visit, and the type of visit may be a good indication of his/her interest level. For instance, a visitor coming from a search engine may have a higher interest level than a visitor who may have followed a hyperlink from a non-search web page. This invention allows advertisers and publishers to set different bid prices and/or different pricing models for different types of visits. In one embodiment, an advertiser may specify a different max cost-per-click (CPC) price for each of the following types of visits:

(a) Search engine referral with search referral query;

(b) Past search referral query; and

(c) Visits that cannot be related to prior search referrals.

Note that while the invention allows the advertisers and publishers to set different maximum price to pay, and minimum price to accept, respectively, for different types of visits, or combinations thereof, it doesn't require them to do so. For instance, search engine referrals with search referral queries may be treated the same as visits with past search referral queries.

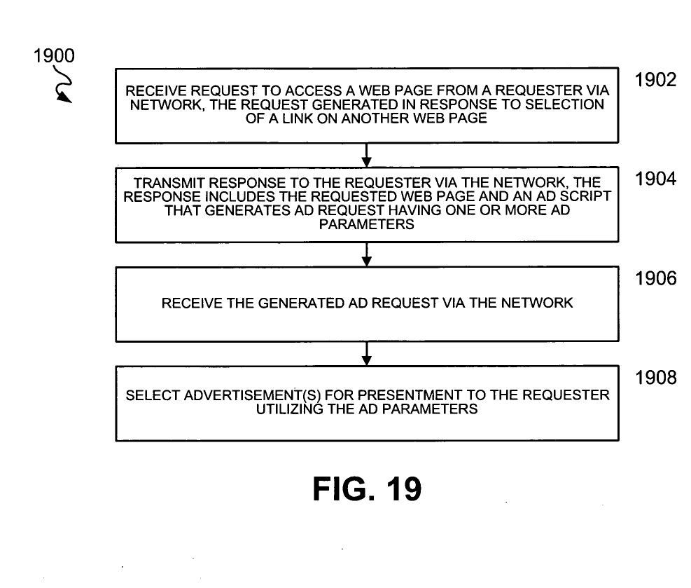

FIG. 19 is a flowchart of a process 1900 for presenting a directed advertisement to a user in accordance with an embodiment of the present invention. In operation 1902 a request from a requester (e.g., a user) to access a web page may be received via a network. The requester may make the request via a browser application on a computer controlled by requester. In one embodiment, the request to access the web page may be generated in response to selection of a hyperlink to the web page on another web page (e.g., a previous web page).

In operation 1904, a response (e.g., a HTTP response) may be transmitted to the requester via the network. The response may be received and executed by the browser application. The response may including information for presenting the requested web page and an ad script. The requested web page may be presented to the requester by the browser application after receipt of the response. The ad script may be executed by the browser application of the requester after receipt of the response from the network by the browser application of the requester. During execution, the ad script may generate an ad request that includes one or more ad parameters that may be extracted from the browser application by the ad script. The generated ad request may then be transmitted via the network. The ad parameters may include information about a network address of the other page (e.g., a URL of the second web page).

In operation 1906, the ad script generated by the ad script may be received via the network. One or more one or more advertisements that may be targeted to the requested may then be selected for presentment to the requester based on the ad parameters of the ad request.

In one embodiment, the request may include a selection (e.g., a link to a web page URL) from a set of search results generated by a search engine and presented to the requester in response to a search query to the search engine initiated by the requester. The ad parameters may include information about the search query. In such an embodiment, the search query may include one or more search terms. These search terms may be included in the ad parameters. In another such embodiment, the one or more search terms may be included in the network address of the other page. In one embodiment, the ad parameters may include a network location associated with a geographic location of the requester. In yet another embodiment, the ad parameters may include information about a publisher of the web page. In one implementation, the ad parameters may include a referrer URL and a publisher URL.

In one embodiment, the selection of the one or more advertisements for presentment to the requester may be achieved by determining whether any advertisements of a set of advertisements matches criteria based on the ad parameters, and then selecting the advertisements from the set of advertisements that match the criteria.

In another embodiment, information about past behavior of the requester may be collected. In such an embodiment, the ad parameters may include at least a portion of the information about past behavior of the requester. The information about past behavior of the requestor may be stored with the help of a cookie, for example. In such an implementation, past behavior of the requester may be extracted using a cookie. In one illustrative implementation, information about the requester's past behavior may be stored in a database, indexed by a cookie, on the ad server. As a further option, the collected information about past behavior may include information one or more previous search queries (i.e., information about the search terms of the previous search queries) issued by the requester.

In a further embodiment, information about previous accesses to the web page may be collected and used to determine a context of the web page. The context information about the web page may then be utilized in the selection of the one or more advertisements. As ano option, the collected information about the previous accesses to the web page may include information about one or more search queries posed to a search engine that resulted in the selection of a link to the web page in the search results returned by the search engine.

In yet another embodiment, an account associated with at least one of the selected advertisements is charged a fee. In one such embodiment, the request may be categorized based on at least whether or not the request arises from a selection of a search result generated by a search engine in response to a search query. The fee charged to the account may then be dependant on the categorization of the request.

In accordance with embodiments of the present invention, the following terms may be defined as follows.

Ad request may refer to a request for advertisement(s). In one embodiment of the invention, such a request may be sent by a browser, on behalf of a user, to an ad server, using HTTP. Ad request may contain several parameter values that may help ad server in targeting ads.

Ad script may refer to a computer program that may help in requesting, receiving, and displaying advertisement(s). In one embodiment, ad script may be a computer program written in Javascript that may be included in a web page. Upon receiving the web page, a browser may execute the ad script, which may result in the browser sending an ad request to an ad server.

Ad server may refer to a server that may execute the computer programs associated with this invention, among others, to target ads based on the parameters provided by the ad script, among other information.

Ad targeting may refer to a process of selecting and/or dynamically constructing ads that may be relevant to a user visiting a web page.

Ad targeting algorithm may refer to a method used for ad targeting.

Advertisement or ad may refer to any piece of text, image, audio, video, or any combination of these. In one embodiment, advertisement may be displayed alongside a web page in the same browser window, or in another browser window as a pop-up, pop-over, pop-off, pop-under, etc. Advertisement may include information about an entity referred to as an advertiser. Advertisement may also include a hyperlink to a web page on advertiser's web site, referred to as advertiser landing page, such that if a user selects the advertisement, the advertiser landing page is displayed to him/her. Advertiser may be a separate and distinct entity from the publisher who owns the web page where the advertiser's advertisement may be displayed. In such a situation, various financial/commercial arrangements may be associated with the display and/or selection and/or conversion of the ads. In other scenarios, on a given web page of a given web site, the web site publisher may choose to advertise different sections of the same web site, or other web sites belonging to the same publisher. This is sometimes referred to as “self-advertising” or “cross-advertising”.

Advertiser may refer to an entity that may sponsor one or more advertisement(s) that may include information about the advertiser, and may be displayed on a web page.

Advertiser landing page may refer to a web page a link to which may be included in an advertisement, such that if a user selects the advertisement, the advertiser landing page may be displayed to the user.

Advertiser landing page URL may refer to the Universal Resource Locator (URL) of an advertiser landing page.

Advertiser preference may refer to an advertiser's preference regarding where they would like their ads to be displayed. This may include choosing particular web sites or web pages where they may like their ads displayed, or choosing particular web sites or web pages where they may not like their ads displayed.

Advertiser bid price may refer to the maximum price that an advertiser may be willing to pay. Depending on the pricing model, this may refer to the maximum price each time the ad is shown (“per impression”), selected (“per click-through”), or converted into a customer (“per acquisition”), among other pricing models.

Advertiser web server may refer to a server that serves up an advertiser landing page.

Anchor text, or link text, may refer to the text that appears in a web page as the user readable portion of a hyperlink, often using text formatting different from the surrounding text. It may be implemented in HTML as: <A HREF=“http://www.site.com/page.html”>anchor text</A>

Auto-categorization may refer to the process of computer classification of documents (which could be web pages) into either pre-defined or dynamically generated categories. An example of such a program is available from Autonomy (www.autonomy.com).

Bookmarks are a feature of many modem day browsers such as for example, Internet Explorer and Netscape, which allows a user to “remember” a web page that he/she has visited. This allows the user to visit that web page again without having to enter the URL of the web page.

Browser may refer to an application typically running on a user's computer that may display web pages to the user.

Browser open box may refer to a box, displayed to a user when he/she selects the open feature of a browser, into which the user inputs a URL corresponding to a web page that he/she wants to visit.

Cookie may refer to a message sent to a web browser by a web server. The message may then be sent back to the web server each time the browser requests a page from the server. One of the purposes of cookies may be to identify users and possibly prepare customized web pages for them.

Conversion may refer to a visitor performing a certain desirable action on a publisher's or advertiser's web site. Examples of desirable actions could be “visit advertiser's landing page”, “sign up as a new user on advertiser's web site”, “purchase a product on advertiser's web site” etc. Conversion rate may refer to the percentage of visitors that perform the specified, desirable action. For instance, an advertiser may be interested in tracking the “sales conversion rate” due to a particular ad. This may refer to the percentage of visitors referred by the ad, who purchased any product on the advertiser's web site.

Click-through-rate (CTR) may refer to the total number of times an advertisement was selected to the number of times the advertisement was displayed.

Commission may refer to the money, or other consideration, paid by the advertiser when a visitor referred by an advertisement performs a certain desirable action such as for example, purchasing a product on the advertiser's web site.

“document.referrer”—This is the special Javascript variable that contains the Referrer URL of the web page that the Javascript code is a part of.

“document.URL”—This is the special Javascript variable that contains the URL of the web page that the Javascript code is a part of.

Geo-locating technique may refer to a technique that may map an IP address to a geographic area where the computer with that IP address is located. Granularity of the geographic area to which an IP address can be mapped depends on the technique. Examples of a geographic area include a ZIP code, city, state, or country. An example of a geo-locating technique may be found at Quova (www.quova.com).

HTTP, or Hyper Text Transfer Protocol, is a set of rules (protocol) that govern the exchange of most documents and data over the World Wide Web. It is typically used by Web browsers to send requests for a web page to Web Servers, and by the Web Server to send the response, which may contain the web page requested, back to the browser. Current version of HTTP that is widely used is version 1.1, and is described in Request For Comments (RFC) 2616. It can be obtained from www.w3c.org

HTTP Request may refer to a request, specified using HTTP rules, for a web document, such as for example, a web page or an advertisement.

Hyperlink may refer to a link to a web page A that is included in another web page B such that when web page B is displayed to a user, the hyperlink to web page A may be highlighted, and if the user selects the hyperlink, the web page B may be displayed to the user.

Impression limit may refer to the maximum number of times that an advertisement may be shown to the same user within a specified time interval, as identified by a cookie. An example of an impression limit is “10 impressions in 12 hours”.

Inverse Document Frequency (IDF) is used to weight the frequency of a particular word in a web page. It may be used to compute a web page's similarity to another web page, its relevance to a search query. Refer to the book “Mining the web: Discovering Knowledge from Hypertext Data” by Soumen Chakrabarti, for a discussion.

Javascript: Javascript is a popular scripting language used to write portions of web pages. Javascript code is typically executed by the browser. There are many books that describe Javascript. One such book is “Mastering Javascript and Jscript” by James Jaworski.

Past search referral query may refer to a search referral query that a user may have used, prior to the current visit, to find and access a web page.

Publisher may refer to an entity that creates and publishes web pages with content, often with the purpose of generating revenues off the traffic to the pages.

Publisher web page may refer to a web page created by a publisher that is available for access over the Internet.

Publisher web page URL may refer to the Uniform Resource Locator (URL) that identifies a publisher web page.

Publisher preference may refer to a publisher's preferences regarding ads they may like to display on their web site, or web pages. This may include choosing particular advertisers or ads that they would like to display on their web site or web pages, or particular advertisers or ad that they would not like to display on their web site or web pages.

Publisher web server may refer to a web server that serves the publisher web page.

Redirecting web pages is a special type of web page that includes a pointer to another web page. In one embodiment, when a browser requests a redirecting web page, it may receive a special HTTP response code of 302, along with a URL. Upon receiving such a response, the browser may automatically request the URL included in the response.

Redirection server may refer to one or a group of computers executing a computer program associated with this invention, among others, that may receive a request from a browser after a user has selected one of the advertisements. Upon receiving the request, redirection server may store information about the user, advertiser, publisher, and the advertisement(s) displayed and selected. Redirection server may also send back to the browser a URL for the advertiser landing page.

Referrer URL, for a given visit to a web page P, may refer to the URL of the web page that included the hyperlink to P that the user selected to visit P. If the user didn't select a hyperlink to visit P, then, the Referrer URL may be undefined.

Referrer Page may refer to the web page corresponding to the Referrer URL.

Search Box may refer to the part of the UI (e.g. a search engine web page) that prompts and enables users to type in the keywords to search for.

Search Engine may refer to a computer program that may allow users to enter a search query, along with other options, and may return links to documents (e.g. web pages) that satisfy or match the search query entered. Examples include World Wide Web (WWW) search engines like Yahoo (www.yahoo.com), Google (www.google.com) etc., intranet search engines like Verity (www.verity.com), or web site-search engines like Freefind (www.freefind.com) and Ultraseek (www.verity.com), among others.

Search query may refer to the information that a user provides to a search engine, in order to describe what kind of document(s) he/she is looking for. For instance, search query may be a set of words (e.g. “keywords”) along with special commands (e.g. “search operators”) that may describe what the user is looking for. Search operators may include boolean ( e.g. +, −, AND, OR, NOT) and phrase operators (e.g. QUOTE, NEAR). Examples of search query strings include:
cat—find all documents with word cat
cat AND dog—find all documents with word cat and dog
cat OR dog—find all documents with word cat or dog
+cat−dog—find all documents with word cat but not dog
“cat dog” —find all documents with the phrase “cat dog”

Search referral URL may refer to a special case of referrer URL when referrer URL corresponds to a results page of a search engine. In other words, if a user is visiting a web page P as a result of selecting a result entry on the results page of a search engine, the search referral URL for that particular visit is the URL of the results page. An example of a search referral URL is http:/www.google.com/search?hl=en&ie=UTF-8&q=best+type+of+weight+loss+diet&btnG=Google+Search

Search referral query, for a given visit of a user to a web page, may refer to a search query that the user may have entered on a search engine, before being referred to that web page. In certain situations, a user may visit a search engine, such as for example, Yahoo (www.yahoo.com) or Google (www.google.com). He/she may enter a search query, say Q, on such a search engine. He/she may select one of the web pages, say P, shown as part of the result of his/her query. Search referral query, for that particular visit to the web page P, is Q. It may be possible, in certain situations, to extract the search referral query from the search referral URL. For instance, in the search referral URL htty:/www.google.com/search?hl=en&ie=UTF-8&q=best+type+of+weight+loss+diet&btnG=Google+Search, it may be possible, using automatic parsing, to extract the search referral query “best type of weight loss diet”.

Search results, or search results page, or results page, may refer to a web page a search engine may display in response to a search query. It may include, among other items, links to pages or documents that match or satisfy the search query entered.

Selecting a search result or selecting a hyperlink, or selecting an advertisement may refer to user's action of choosing a specific result, hyperlink, or advertisement. This may be accomplished by, but not limited to, clicking, using a mouse or other pointer device, on the hyperlink associated with the result, hyperlink, or the advertisement.

Similarity of web pages/documents may refer to the degree to which two or more pages/documents share certain characteristics. For instance, two web pages may be said to be similar if they contain many identical words. There are many techniques of computing “similarity” between two documents or web pages that are described in Information Retrieval (IR) literature. A survey of such techniques may be found in the book “Modem Information Retrieval” by Ricardo Baeza-Yates and Berthier Ribeiro-Neto.

Term Collection may refer to a collection of terms (e.g. words) that appear in a certain web page or document, along with the frequency of each term.

User or visitor may refer to a person or entity that is visiting a web page.

User IP address may refer to the IP address associated with a user's request, as seen by the recipient of the user's request, such as for example, an ad server. Sometimes, the IP address seen by the recipient is not the actual IP address of the user's computer. Instead, it may be the IP address of one of the network devices, such as for example, proxies, that the request may have traveled through. For the purposes of this document, that IP address will be used as the user's IP address.

Visitor is the same as a user.

Web page/web site profile may refer to a collection of characteristics of a web page/web site from an advertising perspective. The profile may help determine what type of ads to display to a user visiting the web page/web site.

Web page may refer to a document on the World Wide Web (WWW) that is identified by a URL. For instance, “http://www.yahoo.com/index.htm” is a web page. A web page may include “Embedded URLs”, such as for example embedded images, and scripts, such as for example javascripts, etc. In order to display the web page, a browser may have to fetch the documents corresponding to these embedded URLs, as well as execute the scripts embedded in the web page.

Web site may refer to a collection of web pages under the same domain name. For instance, all the web pages that have “yahoo.com” as their domain name may be said to belong to the web site yahoo.com, or simply Yahoo.

### Exemplary Network

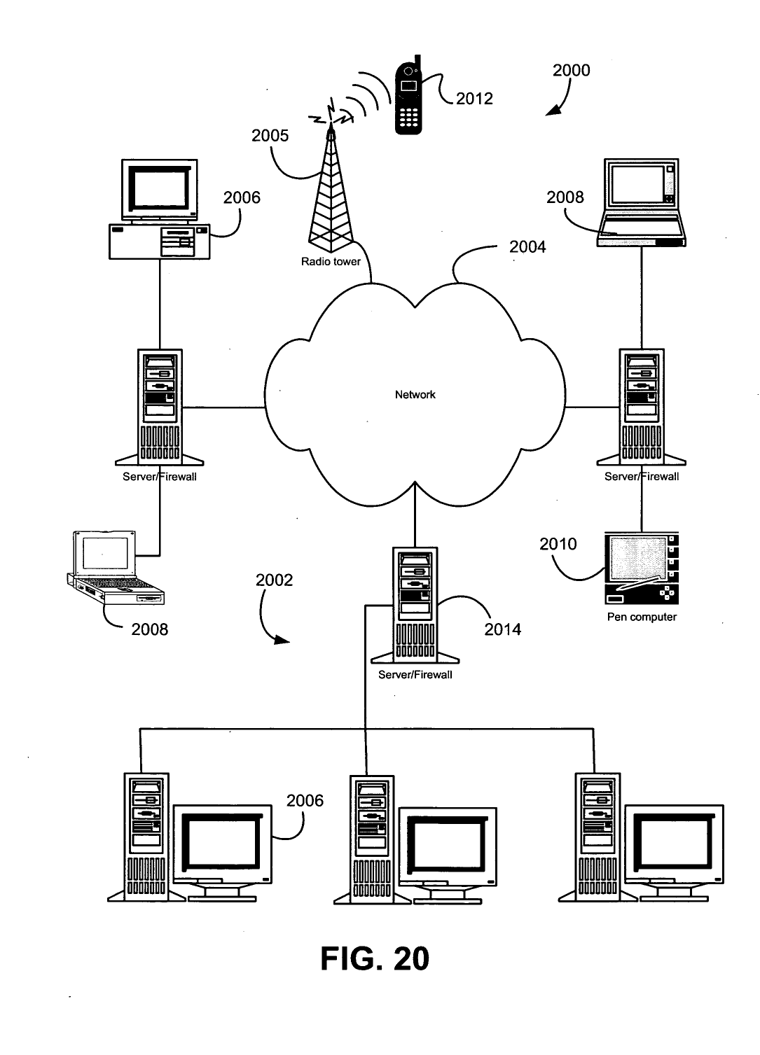

FIG. 20 illustrates an exemplary network system 2000 with a plurality of components 2002 in accordance with one embodiment of the present invention. As shown, such components include a network 2004 which take any form including, but not limited to a local area network, a wide area network such as the Internet, and a wireless network 2005. Coupled to the network 2004 is a plurality of computers which may take the form of desktop computers 2006, lap-top computers 2008, hand-held computers 2010 (including wireless devices 2012 such as wireless PDA's or mobile phones), or any other type of computing hardware/software. As an option, the various computers may be connected to the network 2004 by way of a server 2014 which may be equipped with a firewall for security purposes. It should be noted that any other type of hardware or software may be included in the system and be considered a component thereof.

### Representative Hardware Environment

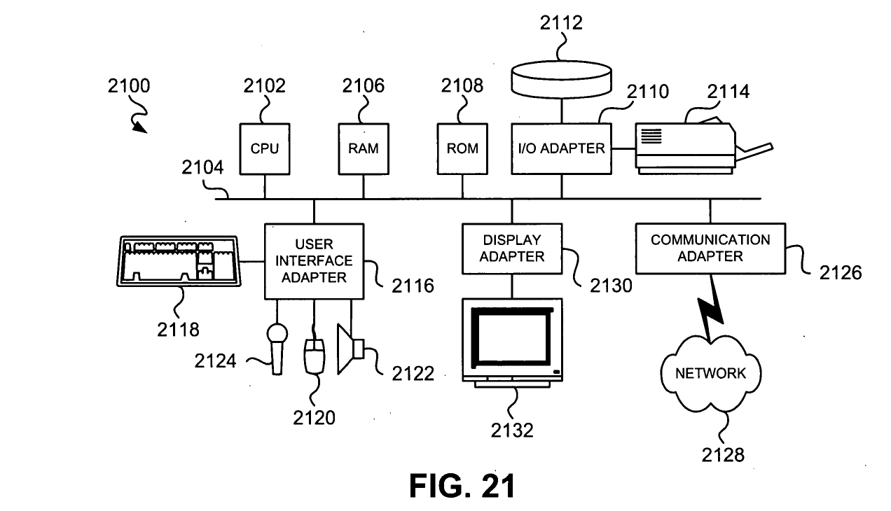

A representative hardware environment associated with the various components of FIG. 20 is depicted in FIG. 21. In the present description, the various sub-components of each of the components may also be considered components of the system. For example, particular software modules executed on any component of the system may also be considered components of the system. In particular, FIG. 21 illustrates an exemplary hardware configuration of a workstation 2100 having a central processing unit 2102, such as a microprocessor, and a number of other units interconnected via a system bus 2104.

The workstation shown in FIG. 21 includes a Random Access Memory (RAM) 2106, Read Only Memory (ROM) 2108, an I/O adapter 2110 for connecting peripheral devices such as, for example, disk storage units 2112 and printers 2114 to the bus 2104, a user interface adapter 2116 for connecting various user interface devices such as, for example, a keyboard 2118, a mouse 2120, a speaker 2122, a microphone 2124, and/or other user interface devices such as a touch screen or a digital camera to the bus 2104, a communication adapter 2126 for connecting the workstation 2100 to a communication network 2128 (e.g., a data processing network) and a display adapter 2130 for connecting the bus 2104 to a display device 2132. The workstation may utilize an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

An embodiment of the present invention may also be written using Java, C, and the C++ language and utilize object oriented programming methodology. Object oriented programming (OOP) is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine.

Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

JavaScript is an interpreted programming or script language from Netscape. It is somewhat similar in capability to Microsoft's Visual Basic, Sun's Tcl, the UNIX-derived Pern, and IBM's REX. In general, script languages are easier and faster to code in than the more structured and compiled languages such as C and C++. JavaScript is used in Web site development to do such things as: automatically change a formatted date on a Web page; cause a linked-to page to appear in a popup window; and cause text or a graphic image to change during a mouse rollover.

JavaScript uses some of the same ideas found in Java. JavaScript code can be imbedded in HTML pages and interpreted by the Web browser (or client). JavaScript can also be run at the server as in Microsoft's Active Server Pages before the page is sent to the requestor. Both Microsoft and Netscape browsers support JavaScript.

Another technology that provides similar function to Java is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for Java without undue experimentation to practice the invention.

A technology of Active X is the component object model (COM). Used in a network with a directory and additional support, COM becomes the distributed component object model (DCOM). The main thing that you create when writing a program to run in the ActiveX environment is a component, a self-sufficient program that can be run anywhere in your ActiveX network. This component is known as an ActiveX control. ActiveX is Microsoft's answer to the Java technology from Sun Microsystems. An ActiveX control is roughly equivalent to a Java applet.

OCX stands for “Object Linking and Embedding control.” Object Linking and Embedding (OLE) was Microsoft's program technology for supporting compound documents such as the Windows desktop. The Component Object Model now takes in OLE as part of a larger concept. Microsoft now uses the term “ActiveX control” instead of “OCX” for the component object.

An advantage of a component is that it can be re-used by many applications (referred to as component containers). A COM component object (ActiveX control) can be created using one of several languages or development tools, including C++ and Visual Basic, or PowerBuilder, or with scripting tools such as VBScript.

Transmission Control Protocol/Internet Protocol (TCP/IP) is a basic communication language or protocol of the Internet. It can also be used as a communications protocol in the private networks called intranet and in extranet. When you are set up with direct access to the Internet, your computer is provided with a copy of the TCP/IP program just as every other computer that you may send messages to or get information from also has a copy of TCP/IP.

TCP/IP is a two-layering program. The higher layer, Transmission Control Protocol (TCP), manages the assembling of a message or file into smaller packet that are transmitted over the Internet and received by a TCP layer that reassembles the packets into the original message. The lower layer, Internet Protocol (IP), handles the address part of each packet so that it gets to the right destination. Each gateway computer on the network checks this address to see where to forward the message. Even though some packets from the same message are routed differently than others, they'll be reassembled at the destination.

TCP/IP uses a client/server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. (Note that the TCP layer itself is not stateless as far as any one message is concerned. Its connection remains in place until all packets in a message have been received.).

Many Internet users are familiar with the even higher layer application protocols that use TCP/IP to get to the Internet. These include the World Wide Web's Hypertext Transfer Protocol (HTTP), the File Transfer Protocol (FTP), Telnet which lets you logon to remote computers, and the Simple Mail Transfer Protocol (SMTP). These and other protocols are often packaged together with TCP/IP as a “suite.”Personal computer users usually get to the Internet through the Serial Line Internet Protocol (SLIP) or the Point-to-Point Protocol. These protocols encapsulate the IP packets so that they can be sent over a dial-up phone connection to an access provider's modem.

Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Internetwork Packet Exchange (IPX) is a networking protocol from Novell that interconnects networks that use Novell's NetWare clients and servers. IPX is a datagram or packet protocol. IPX works at the network layer of communication protocols and is connectionless (that is, it doesn't require that a connection be maintained during an exchange of packets as, for example, a regular voice phone call does).

Packet acknowledgment is managed by another Novell protocol, the Sequenced Packet Exchange (SPX). Other related Novell NetWare protocols are: the Routing Information Protocol (RIP), the Service Advertising Protocol (SAP), and the NetWare Link Services Protocol (NLSP).

A virtual private network (VPN) is a private data network that makes use of the public telecommunication infrastructure, maintaining privacy through the use of a tunneling protocol and security procedures. A virtual private network can be contrasted with a system of owned or leased lines that can only be used by one company. The idea of the VPN is to give the company the same capabilities at much lower cost by using the shared public infrastructure rather than a private one. Phone companies have provided secure shared resources for voice messages. A virtual private network makes it possible to have the same secure sharing of public resources for data.

Using a virtual private network involves encryption data before sending it through the public network and decrypting it at the receiving end. An additional level of security involves encrypting not only the data but also the originating and receiving network addresses. Microsoft, 3Com, and several other companies have developed the Point-to-Point Tunneling Protocol (PPP) and Microsoft has extended Windows NT to support it. VPN software is typically installed as part of a company's firewall server.

Wireless refers to a communications, monitoring, or control system in which electromagnetic radiation spectrum or acoustic waves carry a signal through atmospheric space rather than along a wire. In most wireless systems, radio frequency (RF) or infrared transmission (IR) waves are used. Some monitoring devices, such as intrusion alarms, employ acoustic waves at frequencies above the range of human hearing.

Early experimenters in electromagnetic physics dreamed of building a so-called wireless telegraph. The first wireless telegraph transmitters went on the air in the early years of the 20th century. Later, as amplitude modulation (AM) made it possible to transmit voices and music via wireless, the medium came to be called radio. With the advent of television, fax, data communication, and the effective use of a larger portion of the electromagnetic spectrum, the original term has been brought to life again.

Common examples of wireless equipment in use today include the Global Positioning System, cellular telephone phones and pagers, cordless computer accessories (for example, the cordless mouse), home-entertainment-system control boxes, remote garage-door openers, two-way radios, and baby monitors. An increasing number of companies and organizations are using wireless LAN. Wireless transceivers are available for connection to portable and notebook computers, allowing Internet access in selected cities without the need to locate a telephone jack. Eventually, it will be possible to link any computer to the Internet via satellite, no matter where in the world the computer might be located.

A Global Positioning System (GPS) comprises a number of satellites orbiting the Earth that make it possible for user with GPS receivers to pinpoint their geographic location. In general, the satellites may be spaced apart so that from any point on Earth, four satellites will be above the horizon. Each satellite contains a computer, an atomic clock, and a radio. With an understanding of its own orbit and the clock, the satellite continually broadcasts its changing position and time. (Once a day, each satellite checks its own sense of time and position with a ground station and makes any minor correction.) The GPS receiver includes a computer that “triangulates” its own position by getting bearings from three of the four satellites. The result is provided in the form of a geographic position in longitude and latitude. A GPS receiver may also be equipped with a display screen that shows a map so that the receiver's position can be shown on the map. In addition, if a fourth satellite may be received, the receiver/computer may be able to calculate the altitude of the receiver.

Bluetooth is a computing and telecommunications industry specification that describes how mobile phones, computers, and personal digital assistants (PDA's) can easily interconnect with each other and with home and business phones and computers using a short-range wireless connection. Each device is equipped with a microchip transceiver that transmits and receives in a previously unused frequency band of 2.45 GHz that is available globally (with some variation of bandwidth in different countries). In addition to data, up to three voice channels are available. Each device has a unique 48-bit address from the IEEE 802 standard. Connections can be point-to-point or multipoint. The maximum range is 10 meters. Data can be presently be exchanged at a rate of 1 megabit per second (up to 2 Mbps in the second generation of the technology). A frequency hop scheme allows devices to communicate even in areas with a great deal of electromagnetic interference. Built-in encryption and verification is provided.

Wi-Fi (short for “wireless fidelity”) is a high-frequency wireless local area network (WLAN). The Wi-Fi technology may be used as an alternative to a wired LAN. Wi-Fi technology may also be installed for a home network. Wi-Fi is specified in the 802.11b specification from the Institute of Electrical and Electronics Engineers (IEEE) and is part of a series of wireless specifications together with 802.11, 802.11a, and 802.11g. All four standards use the Ethernet protocol and CSMA/CA (carrier sense multiple access with collision avoidance) for path sharing.

The 802.11b (Wi-Fi) technology operates in the 2.4 GHz range offering data speeds up to 11 megabits per second. The modulation used in 802.11 may be (and has historically been) phase-shift keying (PSK). The modulation method selected for 802.11b is known as complementary code keying (CCK), which allows higher data speeds and is less susceptible to multipath-propagation interference.

Unless adequately protected, a Wi-Fi wireless LAN may be susceptible to access from the outside by unauthorized users, some of whom have used the access as a free Internet connection. Some exemplary security safeguards that may be implemented to protect a Wi-Fi wireless LAN include, for example, the Wired Equivalent Privacy (WEP) encryption standard, the setup and use of a virtual private network (VPN) or IPsec, and a firewall or DMZ.

Encryption is the conversion of data into a form, called a ciphertext, that cannot be easily understood by unauthorized people. Decryption is the process of converting encrypted data back into its original form, so it can be understood.

The use of encryption/decryption is as old as the art of communication. In wartime, a cipher, often incorrectly called a “code,” can be employed to keep the enemy from obtaining the contents of transmissions (technically, a code is a means of representing a signal without the intent of keeping it secret; examples are Morse code and ASCII). Simple ciphers include the substitution of letters for numbers, the rotation of letters in the alphabet, and the “scrambling” of voice signals by inverting the sideband frequencies. More complex ciphers work according to sophisticated computer algorithm that rearrange the data bits in digital signals.

In order to easily recover the contents of an encrypted signal, the correct decryption key is required. The key is an algorithm that “undoes” the work of the encryption algorithm. Alternatively, a computer can be used in an attempt to “break” the cipher. The more complex the encryption algorithm, the more difficult it becomes to eavesdrop on the communications without access to the key.

Rivest-Shamir-Adleman (RSA) is an Internet encryption and authentication system that uses an algorithm developed in 1977 by Ron Rivest, Adi Shamir, and Leonard Adleman. The RSA algorithm is a commonly used encryption and authentication algorithm and is included as part of the Web browser from Netscape and Microsoft. It's also part of Lotus Notes, Intuit's Quicken, and many other products. The encryption system is owned by RSA Security.

The RSA algorithm involves multiplying two large prime numbers (a prime number is a number divisible only by that number and 1) and through additional operations deriving a set of two numbers that constitutes the public key and another set that is the private key. Once the keys have been developed, the original prime numbers are no longer important and can be discarded. Both the public and the private keys are needed for encryption/decryption but only the owner of a private key ever needs to know it. Using the RSA system, the private key never needs to be sent across the Internet.

The private key is used to decrypt text that has been encrypted with the public key. Thus, if a first party sends a message to a second party, the recipient second party may be able to find out the first party's public key (but not the first party's private key) from a central administrator and encrypt a reply message back to the first party using the first party's own public key. When the first party receives the reply message, the reply message may be decrypted by the first party with the first party's private key. In addition to encrypting messages (which ensures privacy), a first party may be able authenticate themselves to second party so that the second party can confirm the identity of the first party (and thus know that it is really the first party who sent the message) by using a private key to encrypt a digital certificate. When the second party receives the encrypted digital certificate, the second party may use the first party's public key to decrypt it.

Wired Equivalent Privacy (WEP) is a security protocol, specified in the IEEE Wireless Fidelity (Wi-Fi) standard, 802.11b, that is designed to provide a wireless local area network (WLAN) with a level of security and privacy comparable to what is usually expected of a wired LAN. In general, a wired local area network (LAN) may be protected by physical security mechanisms (controlled access to a building, for example) that are effective for a controlled physical environment, but may be ineffective for WLANs because radio waves are not necessarily bound by the walls containing the network. WEP may be utilized to help establish similar protection to that offered by the wired network's physical security measures by encrypting data transmitted over the WLAN. Data encryption may be utilized to protect the vulnerable wireless link between clients and access points. Once such a measure has been taken, other LAN security mechanisms such as, for example, password protection, end-to-end encryption, virtual private networks (VPNs), and authentication may be utilized to help ensure privacy.

A pop-up is a graphical user interface (GUI) display area, usually a small window, that suddenly appears (“pops up”) in the foreground of the visual interface. Pop-ups can be initiated by a single or double mouse click or rollover (sometimes called a mouseover), and also possibly by voice command or can simply be timed to occur. A pop-up window is usually smaller than the background window or interface; otherwise, it is may be called a replacement interface.

On the World Wide Web, JavaScript (and less commonly Java applets) may be used to create interactive effects including pop-up and full overlay windows. A menu or taskbar pulldown can be considered a form of pop-up. So can the little message box you get when you move your mouse over taskbars in many PC applications.

Plug-in applications are programs that can easily be installed and used as part of your Web browser. Initially, the Netscape browser allowed you to download, install, and define supplementary programs that played sound or motion video or performed other functions. These were called helper applications. However, these applications run as a separate application and require that a second window be opened. A plug-in application is recognized automatically by the browser and its function is integrated into the main HTML file that is being presented.

Plug-in applications are programs that can easily be installed and used as part of your Web browser. Initially, the Netscape browser allowed you to download, install, and define supplementary programs that played sound or motion video or performed other functions. These were called helper applications. However, these applications run as a separate application and require that a second window be opened. A plug-in application is recognized automatically by the browser and its function is integrated into the main HTML file that is being presented.

A browser is an application program that provides a way to look at and interact with all the information on the World Wide Web. The word “browser” seems to have originated prior to the Web as a generic term for user interfaces that let you browse (navigate through and read) text files online. By the time the first Web browser with a GUI was generally available (Mosaic, in 1993), the term seemed to apply to Web content, too. Technically, a Web browser may be considered a client program that uses the Hypertext Transfer Protocol (HTTP) to make requests of Web servers throughout the Internet on behalf of the browser user. Many of the user interface features in Mosaic, however, went into the first widely-used browser, Netscape Navigator. Microsoft followed with its Microsoft Internet Explorer. Lynx is a text-only browser for UNIX shell and VMS users. Another browser is Opera. While some browsers also support e-mail (indirectly through e-mail Web sites) and the File Transfer Protocol (FTP), a Web browser may not be required for those Internet protocols and more specialized client programs are more popular.

Hashing is the transformation of a string of characters into a usually shorter fixed-length value or key that represents the original string. Hashing may be used to index and retrieve items in a database because it is faster to find the item using the shorter hashed key than to find it using the original value. It may also used in encryption algorithms. A hashing algorithm is called the hash function. Hashing may also used to encrypt and decrypt digital signatures (used to authenticate message senders and receivers). The digital signature is transformed with the hash function and then both the hashed value (known as a message-digest) and the signature are sent in separate transmissions to the receiver. Using the same hash function as the sender, the receiver derives a message-digest from the signature and compares it with the message-digest it also received. They should be the same. The hash function may be used to index the original value or key and then used later each time the data associated with the value or key is to be retrieved. Thus, hashing is always a one-way operation. There's no need to “reverse engineer” the hash function by analyzing the hashed values. In fact, the ideal hash function can't be derived by such analysis. A good hash function also should not produce the same hash value from two different inputs. If it does, this is known as a collision. A hash function that offers an extremely low risk of collision may be considered acceptable.

Some exemplary hash functions include the division-remainder method, the folding method, the radix transformation method and the digit rearrangement method. In the division-remainder method, the size of the number of items in the table is estimated. That number is then used as a divisor into each original value or key to extract a quotient and a remainder. The remainder is the hashed value. The folding method divides the original value into several parts, adds the parts together, and then uses the last four digits (or some other arbitrary number of digits) as the hashed value or key. The radix transformation method may be utilized where the value or key is digital. In this method, the number base (or radix) can be changed resulting in a different sequence of digits. For example, a decimal numbered key could be transformed into a hexadecimal numbered key. High-order digits can be discarded to fit a hash value of uniform length. The digit rearrangement method is simply the taking of part of the original value or key such as digits in positions 3 through 6, reversing their order, and then using that sequence of digits as the hash value or key.

A hash function that works well for database storage and retrieval might not work as for cryptographic or error-checking purposes. There are several well-known hash functions used in cryptography. These include the message-digest hash functions MD2, MD4, and MD5, used for hashing digital signatures into a shorter value called a message-digest, and the Secure Hash Algorithm (SHA), a standard algorithm, that makes a larger (60-bit) message digest and is similar to MD4.

A timestamp may be an identifier for transaction that may be used to permit ordering. A timestamp may also be used to verify digital signatures and help reduce the possibility that someone will derive a private key from the public key in a digital certificate. In order to reduce the possibility that someone will derive a private key from the public key in a digital certificate, the certifying authority may issue the key pair with an expiration date so that they must be replaced periodically. Any signature applied after the digital certificate expires is invalid. To assure that a signature was applied before the certificate expired, the certifying authority can timestamp a digital signature. Essentially, that means taking the signature, adding the current time and signing them together. When a digital signature is timestamped in this way, the software can verify that the signature was applied while the certificate was still valid. U.S. Pat. No. 5,136,647 issued to S. A. Haber et al. on Aug. 4, 1992, entitled “Method for secure timestamping of digital documents” is incorporated herein by reference and discloses a variety of technological and algorithmic components of digital timestamping including the linking of timestamp requests in a sequence, a random-witness method that uses the document being timestamped to pseudo-randomly choose timestamping witnesses, the use of a single hash value to represent a timestamp request for an accumulation or collection of digital documents, and a time-stamping process that does not explicitly require the use of a digital signature.

The Secure Sockets Layer (SSL) is a commonly-used protocol for managing the security of a message transmission on the Internet. SSL has recently been succeeded by Transport Layer Security (TLS), which is based on SSL. SSL uses a program layer located between the Internet's Hypertext Transfer Protocol (HTTP) and Transport Control Protocol (TCP) layers. SSL is included as part of both the Microsoft and Netscape browsers and most Web server products. Developed by Netscape, SSL also gained the support of Microsoft and other Internet client/server developers as well and became the de facto standard until evolving into Transport Layer Security. The “sockets” part of the term refers to the sockets method of passing data back and forth between a client and a server program in a network or between program layers in the same computer. SSL uses the public-and-private key encryption system from RSA, which also includes the use of a digital certificate.

TLS and SSL are an integral part of most Web browsers (clients) and Web servers. If a Web site is on a server that supports SSL, SSL can be enabled and specific Web pages can be identified as requiring SSL access. Any Web server can be enabled by using Netscape's SSLRef program library which can be downloaded for noncommercial use or licensed for commercial use. TLS and SSL are not interoperable. However, a message sent with TLS can be handled by a client that handles SSL but not TLS.

A SSL protocol is described in the SSL Protocol Version 3.0 by the Transport Layer Security Working Group, Nov. 18, 1996 for providing communications privacy over the Internet and allowing client/server applications to communicate in a way that is designed to prevent eavesdropping, tampering, or message forgery, the disclosure of which is incorporated herein by reference in its entirety.

Transport Layer Security (TLS) is a protocol that ensures privacy between communicating applications and their users on the Internet. When a server and client communicate, TLS ensures that no third party may eavesdrop or tamper with any message. TLS is a successor to the Secure Sockets Layer (SSL). TLS is composed of two layers: the TLS Record Protocol and the TLS Handshake Protocol. The TLS Record Protocol provides connection security with some encryption method such as the Data Encryption Standard (DES). The TLS Record Protocol can also be used without encryption. The TLS Handshake Protocol allows the server and client to authenticate each other and to negotiate an encryption algorithm and cryptographic keys before data is exchanged. The TLS protocol is based on Netscape's SSL 3.0 protocol; however, TLS and SSL are not interoperable. The TLS protocol does contain a mechanism that allows TLS implementation to back down to SSL 3.0. A TLS protocol is described in the document entitled, “The TLS Protocol, Version 1” by the Network Working Group of the Internet Society, 1999, the disclosure of which is incorporated herein by reference in its entirety. This document specifies Version 1.0 of the Transport Layer Security (TLS) protocol. The TLS protocol provides communications privacy over the Internet. The protocol allows client/server applications to communicate in a way that is designed to prevent eavesdropping, tampering, or message forgery.

Wireless Transport Layer Security (WTLS) is the security level for Wireless Application Protocol (WAP) applications. Based on Transport Layer Security (TLS) v1.0 (a security layer used in the Internet, equivalent to Secure Socket Layer 3.1), WTLS was developed to address the problematic issues surrounding mobile network devices—such as limited processing power and memory capacity, and low bandwidth—and to provide adequate authentication, data integrity, and privacy protection mechanisms.

Wireless transactions, such as those between a user and their bank, require stringent authentication and encryption to ensure security to protect the communication from attack during data transmission. Because mobile networks do not provide end-to-end security, TLS had to be modified to address the special needs of wireless users. Designed to support datagrams in a high latency, low bandwidth environment, WTLS provides an optimized handshake through dynamic key refreshing, which allows encryption keys to be regularly updated during a secure session.

The Wired Equivalent Privacy (WEP) algorithm, is part of the 802.11 standard. The 802.11 standard describes the communication that occurs in wireless local area networks (LANs). The Wired Equivalent Privacy (WEP) algorithm is used to protect wireless communication from eavesdropping. A secondary function of WEP is to prevent unauthorized access to a wireless network; this function is not an explicit goal in the 802.11 standard, but it is frequently considered to be a feature of WEP. WEP relies on a secret key that is shared between a mobile station (e.g. a laptop with a wireless Ethernet card) and an access point (i.e. a base station). The secret key is used to encrypt packets before they are transmitted, and an integrity check is used to ensure that packets are not modified in transit. The standard does not discuss how the shared key is established. In practice, most installations use a single key that is shared between all mobile stations and access points.

If someone performs a search using a search query “Q” on a search engine, the ads displayed to him on the search results page may be a function of “Q” (e.g., Google search). Based on the foregoing description, ff, after performing the search, the user clicks on one of the results to go to a web page, under certain circumstances, embodiments of the present invention allow the ads shown on that page to be a function of “Q: as well. This may be accomplished using standard interaction of browsers and javascript (search query may be embedded in the Referrer URL which may be extracted from the Javascript variable document.referrer). Following these steps, if the same user goes to other web pages on the same web site, or web pages on other sites that are also part of an advertising system's network, one can target the ads shown to the user on those pages using Q as well. This may be referred to herein as “targeting using past search query.” Targeting using past search query may be accomplished by associating Q with the user's cookie, when the user first arrives from the search engine. For each web page that is in an advertiser's network, one may store the search queries that people have used before reaching that web page, over a period of time. This may be called the “search profile of a web page.” Search profile helps to provide information about what the web page is about. This information may be used to target ads. For instance, if a user reaches a web page without being referred from a search engine (e.g. he may click on a link to the page that he found on a different web page), but the advertiser system knows that other users have reached this web page after doing a search on “DVD players,” the user may be shown ads related to “DVD players” as well.

With respect to pricing aspects of the present invention, pricing may be based on a “visit type” For example, one may categorize each visit to a web page in one of many categories. For instance, (a) Visit directly referred from a search results page, (b) Visit that is not a direct referral from a search results page, but the user has performed a search in the recent past (say last 5 minutes), and (c) a visit that is not of type (a) or (b). Price bidding may be allowed that is a function of the type of visit the current visit is. For instance, an advertiser may specify that he is willing to pay as much as 20 cents for type “A” visits, 10 cents for type “B” visits, and 5 cents for type “C” visits. Such differentiation may be useful to distinguish between a user who was actively looking for “dvd players” on a search engine and a user who is not actively searching for “dvd players.”

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware to create a computer system or computer sub-system embodying the method of the invention.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

1. A method for presenting an advertisement, comprising:
receiving via a network a request to access a web page from a requester, the request to access the web page being generated in response to selection of a link to the web page on another web page;
transmitting a response to the requester via the network, the response including the requested web page and an ad script for execution after receipt of the response from the network, the ad script generating an ad request that includes one or more ad parameters, the ad parameters including information about a network address of the other page;
receiving the generated ad request via the network; and
selecting one or more one or more advertisements for presentment to the requester utilizing the ad parameters of the ad request.

2. The method of claim 1, wherein the request comprises a selection from a search result generated by a search engine in response to a search query initiated by the requester, and wherein the ad parameters include information about the search query.

3. The method of claim 2, wherein the search query comprises one or more search terms, and wherein the ad parameters include the one or more search terms.

4. The method of claim 3, wherein the one or more search terms are included in the information about the network address of the other page.

5. The method of claim 1, wherein the ad parameters include a network location associated with a location of the requester.

6. The method of claim 1, wherein the ad parameters include information about a publisher of the web page.

7. The method of claim 1, wherein the ad parameters include a referrer URL and a publisher URL associated with the web page.

8. The method of claim 1, wherein the selection of the one or more advertisements for presentment to the requester comprises determining whether any advertisements of a set of advertisements matches criteria based on the ad parameters, and selecting the advertisements from the set of advertisements that match the criteria.

9. The method of claim 1, wherein information about past behavior of the requester is collected, and wherein the selection of the one or more advertisements for presentment to the requester includes using at least a portion of the information about past behavior of the requester.

10. The method of claim 9, wherein the information about past behavior of the requestor is stored and accessed utilizing a cookie, and wherein the ad script extracts the at least a portion of the information about past behavior of the requester utilizing the cookie.

11. The method of claim 9, wherein the collected information about the past behavior includes information about one or more previous search queries.

12. The method of claim 1, wherein information about previous accesses to the web page are collected and used to determine a context of the web page, wherein the context information about the web page is utilized in the selection of the one or more advertisements.

13. The method of claim 12, wherein the collected information about previous accesses to the web page includes information about one or more search queries used on a search engine that resulted in the selection of a link to the web page from search results obtained by the search engine and presented to the requester.

14. The method of claim 1, wherein an account associated with at least one of the selected advertisements is charged a fee.

15. The method of claim 14, wherein the request is categorized based on at least whether or not the request arises from a selection of a search result generated by a search engine in response to a search query, and wherein the fee charged to the account is dependant on the categorization of the request.

16. The method of claim 1, wherein at least one of the advertisements selected for presentment to the requester is dynamically generated based on at least a portion of the one or more ad parameters.

17. A system for presenting an advertisement, comprising:
logic for receiving via a network a request to access a web page from a requester, the request to access the web page being generated in response to selection of a link to the web page on another web page (i.e., a previous web page);
logic for transmitting a response to the requester via the network, the response including the requested web page and an ad script for execution after receipt of the response from the network, the ad script generating an ad request that includes one or more ad parameters, wherein the ad parameters include information about a network address of the other page;
logic for receiving the generated ad request via the network; and
logic for selecting one or more one or more advertisements for presentment to the requester utilizing the ad parameters of the ad request.

18. A computer program product for presenting an advertisement, comprising:
computer code for receiving via a network a request to access a web page from a requester, the request to access the web page being generated in response to selection of a link to the web page on another web page (i.e., a previous web page);
computer code for transmitting a response to the requester via the network, the response including the requested web page and an ad script for execution after receipt of the response from the network, the ad script generating an ad request that includes one or more ad parameters, wherein the ad parameters include information about a network address of the other page;
computer code for receiving the generated ad request via the network; and
computer code for selecting one or more one or more advertisements for presentment to the requester utilizing the ad parameters of the ad request.

19. A method for presenting an advertisement, comprising:
inputting a search query to initiate a search by a search engine via the via a network;
receiving a search result from the search engine via the network, wherein the search result comprises at least one link to a web page;
selecting the link to the web page to access the web page via the network;
receiving the web page via the network, wherein the web page include an ad script that is executed after receipt of the web page, the ad script extracting one or more ad parameters and transmitting an ad request that includes the one or more extracted ad parameters to an ad server via the network, the ad server selecting one or more advertisements based on the ad parameters included in ad request; and
receiving the one or more selected advertisements via the network.

20. The method of claim 19, wherein the one or more extracted ad parameters include information about the search query.

21. The method of claim 20, wherein the information about the search query is contained in a referrer URL associated with the web page.
